(19) United States
(12) Patent Application Publication
(10) Pub. No.: US 2009/0226682 A1
(43) Pub. Date: Sep. 10, 2009

(54) INK COMPOSITION, INK COMPOSITION FOR INK JET RECORDING, INK JET RECORDING METHOD, METHOD FOR PRODUCING INK JET RECORDED MATTER AND INK JET RECORDED MATTER

(76) Inventor: Masahiro YATAKE, Shiojiri-shi (JP)

Correspondence Address: LADAS & PARRY LLP, 26 WEST 61ST STREET, NEW YORK, NY, 10023, US

(21) Appl. No.: 12/396,025

(22) Filed: Mar. 2, 2009

(30) Foreign Application Priority Data
Mar. 3, 2008 (JP) 2008-051710
Mar. 3, 2008 (JP) 2008-051712
Aug. 25, 2008 (JP) 2008-214929
Feb. 12, 2009 (JP) 2009-030344

(51) Int. Cl. C09D 11/02; C08L 33/06; C08K 3/04; B05D 5/00; C08K 5/05; B32B 3/10

(52) U.S. Cl. 428/196; 524/560; 524/496; 427/288; 524/553; 524/380

(57) ABSTRACT

In order to provide an ink composition which is excellent in color development, stability and fixability and, more particularly, an ink for ink jet recording which is excellent in color development, stability and fixability, is excellent as a textile ink for ink jet recording, and is excellent in ejection stability of the ink from an ink jet head, an ink composition includes a dispersion element having an average particle diameter of 50 nm to 300 nm, which allows a pigment to be dispersed in water; polymer fine particles synthesized using at least alkyl(meth)acrylate and/or cyclic alkyl(meth)acrylate as components thereof, having a glass transition temperature of −10° C. or below and having an acid value of 100 mgKOH/g or less; and a reactant.

### CROSS-REFERENCES TO RELATED APPLICATIONS

The entire disclosure of Japanese Patent Application No. 2008-51710, filed on Mar. 3, 2008, No. 2008-51712, filed on Mar. 3, 2008, No. 2008-214929, filed on Aug. 25, 2008, and No. 2009-030344, filed on Feb. 12, 2009, are expressly incorporated by reference herein.

### FIELD OF THE INVENTION

The present invention relates to an ink composition excellent in color development, stability and fixability. More particularly, the invention relates to an ink for ink jet recording, which is excellent as a textile ink for ink jet recording and excellent in color development, stability and fixability, an ink jet recording method, a method for producing ink jet recorded matter and an ink jet recorded matter.

### BACKGROUND OF THE INVENTION

An ink used for ink jet recording requires properties such as a blur-free property in printing onto paper which is a recorded matter, a good drying property, a uniform printing property for the surfaces of various recorded matters, a property in which adjacent colors are not mixed in multi-color printing such as color printing, and so on.

In a known ink, in particular, in the majority of the inks using a pigment, an ink for mainly suppressing permeability so as to suppress wettability of the ink to the surface of paper and leaving ink droplets in the vicinity of the surface of the paper such that printing quality is secured is examined and practically used. However, in the ink for suppressing the wettability to the paper, a blur variation due to a difference in paper kind is large and, in particular, in recycle paper in which various paper components are mixed, blur due to a difference in wettability of the ink to the respective components is generated. In addition, there are problems in such an ink that it consumes a great deal of time to dry the printing, and in multi-color printing such as color printing, adjacent colors get mixed. In addition, in an ink using a pigment as a coloring material, there is a problem that since the pigment is left on the surface of paper or the like, an abrasion-proof property deteriorates.

In order to solve such problems, the improvement of permeability of the ink to the paper is tried, and the addition of diethylene glycol monobutyl ether (see Patent Document 1), the addition of Surfynol 465 which is a surfactant of acethylene glycol (manufactured by NISSIN CHEMICAL INDUSTRY CO., LTD.) (see Patent Document 2), the addition of both diethylene glycol monobutyl ether and Surfynol 465 (see Patent Document 3), and the like have been examined. In addition, the use of diethylene glycol ethers in the ink has been examined (see Patent Document 4).

In addition, in the ink using the pigment, generally, since it is difficult to improve the permeability of the ink while securing the dispersion stability of the pigment and the range of choice for the penetrating agent is narrow, the known combination of glycol ether and the pigment includes an example using triethylene glycol monomethyl ether in the pigment (see Patent Document 5) or an example using ethylene glycol, diethylene glycol or triethylene glycol ethers (see Patent Document 6).

In addition, for textile, for example, there is an example of using a dye (see Patent Document 7), an example of using a binding agent (see Patent Document 8) or the like.

### RELATED ART

[Patent Document 1] U.S. Pat. No. 5,156,675

[Patent Document 2] U.S. Pat. No. 5,183,502

[Patent Document 3] U.S. Pat. No. 5,196,056

[Patent Document 4] U.S. Pat. No. 2,083,372

[Patent Document 5] JP-A-56-147861

[Patent Document 6] JP-A-9-111165

[Patent Document 7] JP-A-2007-515561

[Patent Document 8] JP-A-2007-126635

### SUMMARY OF THE INVENTION

### Problems to be Solved by the Invention

However, in the known aqueous ink, printing quality was insufficient and, more particularly, fixability was insufficient as a textile ink for ink jet recording, and a color concentration or color development was insufficient. In addition, a known pigment dispersion element is unstable, and when a material having a hydrophilic portion and a hydrophobic portion such as a surfactant or glycol ether is present, adsorption/desorption from the pigment of a dispersion polymer is apt to occur and thus the storage stability of the ink deteriorates. A general aqueous ink requires the material having the hydrophilic portion and a hydrophobic portion such as the surfactant or glycol ether, in order to reduce the blur on paper. In the ink which does not use this material, the permeability to the paper is insufficient, the kind of the paper is restricted in order to perform uniform printing, and a printed image is apt to deteriorate.

In addition, if an additive agent (a surfactant of acetylene glycol or acetylene alcohol, di(tri)ethylene glycol monobutyl ether, (di)propylene glycol monobutyl ether, 1,2-alkylene glycol or a mixture thereof) used in the invention is used in the known pigment dispersion element, since the long-term storage stability cannot be obtained and redissolubility of the ink is poor, the ink is dried and is clogged in the end of a nozzle of an ink jet head.

Accordingly, the invention is made to solve such problems and an object of the invention is to provide an ink composition which is excellent in color development, stability and fixability and, more particularly, an ink for ink jet recording which is excellent in color development, stability and fixability, is excellent as a textile ink for ink jet recording, and is excellent in ejection stability of the ink from an ink jet head.

### Means for Solving the Problems

The invention is as follows:

(1) An ink composition comprising: a dispersion element having an average particle diameter of 50 nm to 300 nm, which allows a pigment to be dispersed in water; polymer fine particles synthesized using at least alkyl(meth)acrylate and/or cyclic alkyl(meth)acrylate as components thereof, having a glass transition temperature of −10° C. or below, and having an acid value of 100 mgKOH/g or less; and a reactant.

(2) The ink composition according to (1), wherein the reactant includes at least one kind selected from the group consisting of block isocyanate, oxazoline-containing polymer and polycarbodiimide.

(3) The ink composition according to (1) or (2), wherein the alkyl(meth)acrylate and/or the cyclic alkyl(meth)acrylate are/is alkyl(meth)acrylate having 1 to 24 carbon atoms and/or cyclic alkyl(meth)acrylate having 3 to 24 carbon atoms.

(4) The ink composition according to any one of (1) to (3), wherein the dispersion element is a self-dispersion carbon black of which an average particle diameter is 50 nm to 300 nm so as to be dispersed in water without a dispersion agent.

(5) The ink composition according to any one of (1) to (3), wherein the dispersion element has an average particle diameter of 50 nm to 300 nm so as to allow an organic pigment to be dispersed in water using a polymer, and a styrene-converted weight-average molecular weight by Gel Permeation Chromatography (GPC) of the polymer is 10000 to 200000. (6) The ink composition according to any one of (1) to (5), wherein, in the polymer fine particle, a styrene-converted weight-average molecular weight by Gel Permeation Chromatography (GPC) is 100000 to 1000000.

(7) The ink composition according to any one of (1) to (6), including 1,2-alkylene glycol.

(8) The ink composition according to any one of (1) to (7), including a surfactant of acetylene glycol and/or a surfactant of acetylene alcohol.

(9) The ink composition according to any one of (1) to (8), wherein the content (mass %) of the polymer fine particle is greater than the content (mass %) of the pigment.

(10) An ink for ink jet recording comprising the ink composition according to any one of (1) to (9).

(11) An ink jet recording method comprising printing the ink for ink jet recording according to (10) on a fabric, and heating the fabric, on which the ink for ink jet recording is printed, at 110° C. to 200° C. for 1 or more minutes.

(12) The ink jet recording method according to (11), comprising printing the ink for ink jet recording on the fabric and treating the fabric with an acidic liquid before the fabric on which the ink for ink jet recording is printed is heated, if the ink for ink jet recording contains carbodiimide as the reactant.

(13) A method for producing an ink jet recorded matter, the method comprising printing the ink for ink jet recording according to (10) on a fabric, and heating the fabric, on which the ink is printed, at 110° C. to 200° C. for 1 or more minutes.

(14) An ink jet recorded matter obtained by the ink jet recording method according to any one of (11) and (12) or the method for producing the ink jet recorded matter according to (13).

### DETAILED DESCRIPTION OF THE PRESENT INVENTION

The invention is obtained by an examination which considers the requirement for the properties such as excellent color development, stability and fixability, and particularly, an excellent textile ink for ink jet recording.

An ink composition of the invention includes a dispersion element having an average particle diameter of 50 nm to 300 nm, which allows a pigment to be dispersed in water, polymer fine particles synthesized using at least alkyl(meth)acrylate and/or cyclic alkyl(meth)acrylate as components thereof, having a glass transition temperature of −10° C. or below and having an acid value of 100 mgKOH/g or less, and a reactant.

The “reactant” described herein is a compound having one or more reactive group, that is, a plurality of reactive groups, which reacts with a functional group (for example, a hydroxyl group contained in cellulose) possessed by a fabric, a functional group possessed by a polymer fine particle, a functional group possessed by a dispersion element (resin or the like), or the like, by a proper treatment of a heat treatment or the like. In addition, under the existence of an adequate initiating reagent, a crosslinkable compound which reacts with materials configuring the pigment dispersion agent, the polymer fine particles, the fabric or the like may be used. In addition, as the reactant, for example, a material which is inactivated by the compound alone but is activated by heating or the like, such as block isocyanate, is also included. The block isocyanate is inactivated at a room temperature by allowing a free isocyanate group of an isocyanate group terminal precursor to react with an active hydrogen group-containing compound (block agent), and has a property in which the block agent is dissociated and the isocyanate group is reproduced when block isocyanate is heated.

The ink composition of the invention preferably includes at least one selected from a group consisting of block isocyanate, oxazoline-containing polymer and polycarbodiimide as the reactant, in order to be suitable for the textile ink jet recording.

By the above configuration, rubbing fastness of dry rubbing and wet rubbing when a fabric for textile is printed is improved.

In addition, an ink jet recording method of the invention includes printing an ink for ink jet recording, which includes the above ink composition, on a fabric, and heating the fabric, on which the ink is printed, at 110° C. to 200° C. for 1 or more minutes. If the temperature is lower than 110° C., the fixability of the ink printed on the fabric is not improved. If the temperature exceeds 200° C., the fabric, the pigment, the polymer and the like deteriorate. More preferably, the temperature is in a range from 120° C. to 170° C. The heating time is preferably 1 minute or more. If the time is less than 1 minute, the reaction of the reactant is not sufficiently progressed. That is, for example, if the ink composition includes block isocyanate as the reactant, the reaction of block isocyanate is not sufficiently progressed. In addition, for example, if the ink composition includes oxazoline-containing polymer as the reactant, the reaction of oxazoline of the oxazoline-containing polymer is not sufficiently progressed. In addition, for example, if the ink composition includes polycarbodiimide as the reactant, the reaction of a carboxyl group or an amino group of the polymer used in pigment dispersion or polymer fine particles and a carbodiimide group of polycarbodiimide is not sufficiently progressed. Accordingly, the heating time is more preferably 2 minutes or more.

In addition, the ink jet recording method of the invention preferably includes printing the ink for ink jet recording on the fabric and treating the fabric with an acidic liquid before the fabric on which the ink is printed is heated, if the ink for ink jet recording including the ink composition contains polycarbodiimide as the reactant. The reaction of the carboxyl group or an amino group of the polymer used in pigment dispersion or polymer fine particles and the carbodiimide group of polycarbodiimide is sufficiently progressed by the step of treating the fabric with the acidic liquid. In this case, as the acidic liquid, acid which does not damage the fabric may be used and organic acid or inorganic acid may be used.

In addition, a method for producing an ink jet recorded matter of the invention includes printing an ink for ink jet recording, which includes the above ink composition, on a fabric and heating the fabric, on which the ink is printed, at 110° C. to 200° C. for 1 minute or more. If the temperature is lower than 110° C., the fixability of the ink printed on the fabric is not improved. If the temperature exceeds 200° C., the fabric, the pigment, the polymer and the like deteriorate. More preferably, the temperature is in a range from 120° C. to 170° C. The heating time is preferably 1 minute or more. If the time is less than 1 minute, the reaction of the reactant is not sufficiently progressed. That is, for example, if the ink composition includes block isocyanate as the reactant, the reaction of block isocyanate is not sufficiently progressed. In addition, for example, if the ink composition includes oxazoline-containing polymer as the reactant, the reaction of oxazoline of the oxazoline-containing polymer is not sufficiently progressed. In addition, for example, if the ink composition includes polycarbodiimide as the reactant, the reaction of a carboxyl group or an amino group of the polymer used in pigment dispersion or polymer fine particles and a carbodiimide group of polycarbodiimide is not sufficiently progressed. Accordingly, the heating time is more preferably 2 minutes or more.

The average particle diameters of the pigment dispersion element and the polymer fine particle are measured by a light scattering method. If the average particle diameter of the pigment dispersion element using the light scattering method is less than 50 nm, color development deteriorates. If the average particle diameter of the pigment dispersion element exceeds 300 nm, fixability deteriorates. The average particle diameter of the pigment dispersion element is preferably 70 nm to 230 nm and is more preferably 80 nm to 130 nm. In contrast, the particle diameter of the polymer fine particle is preferably 50 nm to 500 nm and is more preferably 60 nm to 300 nm. If the particle diameter of the polymer fine particle is less than 50 nm, fixability deteriorates and, if the particle diameter of the polymer fine particle exceeds 500 nm, the ejection from the ink jet head is apt to become unstable.

In addition, the glass transition temperature of the polymer fine particle included in the ink composition of the invention is −10° C. or below. If the glass transition temperature is −10° C. or below, the fixability of the pigment as the textile ink is improved. If the glass transition temperature exceeds −10° C., the fixability of the pigment gradually deteriorates. The glass transition temperature is preferably −15° C. or below and is more preferably −20° C.

In addition, the acid value of the polymer fine particle is 100 mgKOH/g or less. If the acid value exceeds 100 mgKOH/g, washing fastness deteriorates when the textile ink is printed on the fabric. The acid value is preferably 50 mgKOH/g or less and is more preferably 30 mgKOH/g or less. In addition, the molecular weight of the polymer fine particle is preferably 100000 or more and is more preferably 200000. If the molecular weight is less than 1000, washing fastness deteriorates when the textile ink is printed on the fabric.

As alkyl(meth)acrylate and/or cyclic alkyl(meth)acrylate included in the polymer fine particle as the component, alkyl(meth)acrylate having 1 to 24 carbon atoms and/or cyclic alkyl(meth)acrylate having 3 to 24 carbon atoms are preferable, and the examples thereof include methyl(meth)acrylate, ethyl(meth)acrylate, propyl(meth)acrylate, n-butyl(meth)acrylate, isobutyl(meth)acrylate, pentyl(meth)acrylate, hexyl(meth)acrylate, 2-ethylhexyl(meth)acrylate, octyl(meth)acrylate, nonyl(meth)acrylate, decyl(meth)acrylate, t-butylcyclohexyl(meth)acrylate, lauryl(meth)acrylate, isoboronyl(meth)acrylate, cetyl(meth)acrylate, stearyl(meth)acrylate, isostearyl(meth)acrylate, tetramethylpiperidyl(meth)acrylate, dicyclopentanyl(meth)acrylate, dicyclopentanyl(meth)acrylate, dicyclopentenlyoxy(meth)acrylate and behenyl(meth)acrylate and so on.

If the polymer fine particle contains components other than the above components, alkyl(meth)acrylate and/or cyclic alkyl(meth)acrylate is preferably set to 70 mass % or more of the components of the polymer fine particle. By this configuration, washing fastness and ejection stability of the ink jet ink for textile can be secured.

The ink composition of the invention preferably includes self-dispersion carbon black of which an average particle diameter is 50 nm to 300 nm so as to be dispersed in water without a dispersion agent, as the dispersion element. By using this self-dispersion carbon black, the color development of a recorded matter is improved. The method of dispersing carbon black in water without the dispersion agent includes a method of oxidizing the surface of carbon black with sodium hypochlorite, ozone or the like. The average particle diameter of such a self-dispersion carbon black dispersion element is preferably 50 nm to 150 nm. If the average particle diameter is less than 50 nm, it is difficult to obtain color development. If the average particle diameter exceeds 150 nm, fixability deteriorates. The particle diameter is more preferably 70 nm to 130 nm and is still more preferably 80 nm to 120 nm.

In addition, the ink composition of the invention includes the dispersion element, of which an average particle diameter is 50 nm to 300 nm so as to allow an organic pigment to be dispersed in water using a polymer and a styrene-converted weight-average molecular weight by Gel Permeation Chromatography (GPC) of the polymer is 10000 to 200000. By this configuration, in particular, the fixability of the pigment as the textile ink is improved and the storage stability of the pigment ink is also improved.

The polymer used in the dispersion of the pigment preferably has a functional group for prompting the reaction with the reactant included in the ink composition and preferably has a carboxyl group or an amino group for prompting the reaction with a polycarbodiimide group, for example, if polycarbodiimide is contained in the ink composition. In order to stabilize the dispersion independent of the dispersion agent, a water dispersible or water dissoluble polymer or surfactant may be added as a dispersion stabilization agent. The polymer configuring the above-described dispersion agent and the dispersion stabilization agent is preferably a polymer due to copolymerization of (meth)acrylate and (meth)acrylic acid by at least 70 mass % or more as the component thereof.

The reactant included in the ink composition of the invention is a compound having at least one reaction group, that is, a plurality of reaction groups, and is not specially limited if it reacts with a functional group (for example, a hydroxyl group contained in cellulose) possessed by a fabric, a functional group possessed by a polymer fine particle, a functional group possessed by a dispersion element (resin or the like), or the like by a proper treatment such as a heating treatment. The ink composition of the invention preferably includes at least one selected from a group consisting of block isocyanate, oxazoline-containing polymer and polycarbodiimide as the reactant.

The block isocyanate included in the ink composition of the invention is polyisocyanate and is preferably aqueous emulsion. As the example thereof, for example, NKLinkerBX (manufactured by SHIN-NAKAMURA CHEMICAL CO., LTD.), FIXER FX CONC (manufactured by MATSUI SHIKISO CHEMICAL CO., LTD.) or the like is commercially available. In addition, the manufacture thereof is possible by the method described in Japanese Unexamined Patent Application Publication No. 2007-45867.

In addition, the oxazoline-containing polymer included in the ink composition of the invention is preferably aqueous emulsion or aqueous polymer. As the example thereof, NKLinkerFX manufactured by SHIN-NAKAMURA CHEMICAL CO., LTD., EPOCROS K-2010, EPOCROS K-2020, EPOCROS K-2030, EPOCROS WS-500, EPOCROS WS-700 or the like, which is manufactured by NIPPON SHOKUBAI CO., LTD., or the like is commercially available.

The polycarbodiimide included in the ink composition of the invention is preferably aqueous emulsion or aqueous polymer. As the example thereof, for example, SV-02, V-02, V-02-L2, V-04, E-01, E-02 or the like of Carbodiright of NISSHINBO is commercially available. Since the reaction of the polycarbodiimide group of the polycarbodiimide with the carboxyl group is apt to be generated at a high temperature or by acid, the polycarbodiimide needs to become an alkaline in the ink state from the viewpoint of the storage stability. As alkali added to the ink, volatile alkali such as ammonia is preferable, but organic amine such as triethanolamine or triisopropanolamine may be used. Preferably, pH is 8 to 11 and is more preferably 8.5 to 10. The molecular weight of the polycarbodiimide is preferably 3000 to 100000. If the molecular weight of the polycarbodiimide is less than 3000, the storage stability of the ink deteriorates and, if the molecular weight of the polycarbodiimide exceeds 100000, the reaction of the polycarbodiimide group with the carboxyl group is hard to be proceeded. The molecular weight of the polycarbodiimide is more preferably 5000 to 30000.

In the polymer fine particle included in the ink composition of the invention, the styrene-converted weight-average molecular weight by the Gel Permeation Chromatography (GPC) is preferably 100000 to 1000000. When the styrene-converted weight-average molecular weight is 100000 to 1000000, in particular, the fixability of the pigment as the textile ink is improved.

The ink composition of the invention preferably uses 1,2-alkylene glycol. By using 1,2-alkylene glycol, blur is reduced and printing quality is improved. As the example of 1,2-alkylene glycol, 1,2-alkylene glycol having 5 or 6 carbon atoms, such as 1,2-hexanediol, 1,2-pentanediol, or 4-methyl-1,2-pentanediol, is preferable. Among them, 1,2-hexanediol and/or 4-methyl-1,2-pentanediol having 6 carbon atoms is preferable. The additive amount of 1,2-alkylene glycol is preferably 0.3 mass % to 30 mass % (which may be, hereinafter, referred to as “%”) and is more preferably 0.5 mass % to 10 mass %.

In addition, the ink composition of the invention may include glycol ether. The glycol ether may be one, two or more selected from diethylene glycol monobutyl ether, triethylene glycol monobutyl ether, propylene glycol monobutyl ether and dipropylene glycol monobutyl ether. In addition, the additive amount of glycol ether is preferably 0.1 mass % to 20 mass % and is more preferably 0.5 mass % to 10 mass %.

The ink composition of the invention preferably includes a surfactant of acetylene glycol and/or a surfactant of acetylene alcohol. By using the surfactant of acetylene glycol and/or the surfactant of acetylene alcohol, blur is further reduced and printing quality is improved. By the addition thereof, a printing drying property is improved and high-speed printing can be realized.

As the surfactant of acetylene glycol and/or the surfactant of acetylene alcohol, one or more selected from an additive of alkylene oxide of 2,4,7,9-tetramethyl-5-decyne-4,7-diol and 2,4,7,9-tetramethyl-5-decyne-4,7-diol, and an additive of an alkylene oxide of 2,4-dimethyl-5-decyne-4-ol and 2,4-dimethyl-5-decyne-4-ol is preferable. These can be obtained from Surfynol 465, Surfynol 61 or the like which is manufactured by NISSIN CHEMICAL INDUSTRY CO., LTD. or E series such as Olfine 104 series, Olfine E1010 series manufactured by AIR PRODUCTS (England).

In the ink composition of the invention, using one, two or more selected from a group consisting of the 1,2-alkylene glycol, the surfactant of acetylene glycol and/or the surfactant of acetylene alcohol, and the glycol ether, blur is further reduced.

In the ink composition of the invention, the content (mass %) of the polymer fine particle is preferably larger than the content (mass %) of the pigment. By adding the polymer fine particle more than the pigment in the mass unit, the fixability of the pigment as the textile ink is improved. In addition, for textile, by inserting a cleaning process using water or water containing a surfactant after a fabric is printed, an aqueous component of the ink is washed off. Thus, the fixing of the polymer fine particle to the fabric becomes strong and the abrasion-proof property can be further improved.

As the pigment contained in the dispersion element included in the ink composition of the invention, as a black ink, carbon black (C.I. pigment black 7) such as furnace black, lamp black, acethylene black, channel black or the like is particularly preferable, but an organic pigment such as cuprate, ferrioxide (C.I. pigment black 11), metals such as titanium oxide or the like, aniline black (C.I pigment black 1) or the like may be used.

In addition, as color inks, C.I. pigment yellow 1 (fast yellow G), 3, 12 (disazo yellow-AAA), 13, 14, 17, 24, 34, 35, 37, 42 (yellow iron oxide), 53, 55, 74, 81, 83 (disazo yellow-HR), 93, 94, 95, 97, 98, 100, 101, 104, 108, 109, 110, 117, 120, 128, 138, 153, 155, 180, 185, C. I. pigment red 1, 2, 3, 5, 17, 22 (brilliant fast scarlet), 23, 31, 38, 48:2 (permanent red 2B (Ba)), 48:2 (permanent red 2B (Ca)), 48:3 (permanent red 2B (Sr)), 48:4 (permanent red 2B (Mn)), 49:1, 52:2, 53:1, 57:1 (brilliant carmine 6B), 60:1, 63:1, 63:2, 64:1, 81 (rhodamine 6G lake), 83, 88, 101 (red iron oxide)), 104, 105, 106, 108 (cadmium red), 112, 114, 122 (quinacridone magenta), 123, 146, 149, 166, 168, 170, 172, 177, 178, 179, 185, 190, 193, 202, 206, 209, 219, 254, C. I. pigment violet 19, 23, C. I. pigment orange 36, C.I. pigment blue 1, 2, 15 (phthalocyanine blue R), 15:1, 15:2, 15:3 (phthalocyanine blue G), 15:4, 15:6 (phthalocyanine blue E), 16, 17:1, 56, 60, 63, C. I. pigment green 1, 4, 7, 8, 10, 17, 18, 36, or the like may be used. As the coloring agent, various pigments may be used.

The above-described pigments are dispersed using a disperser and various commercially available dispersers may be used as the disperser. Non-media dispersion is preferable from the viewpoint of low contamination. As the detailed example thereof, there are a wet jet mill (JIINASU KK), a nanomizer (NANOMIZER Co. Ltd.), a homogenizer (Gaulin), an ultimizer (SUGINO MACHINE LIMITED), a microfludizer (Microfluidics) and so on.

In the case where the ink composition of the invention is used as the ink for ink jet recording, the additive amount of pigment is preferably 0.5 mass % to 30 mass % and is more preferably 1.0 mass % to 15 mass %. In the additive amount of less than 0.5 mass %, printing concentration cannot be secured and, in the additive amount of more than 30 mass %, the viscosity of the ink is increased or structural viscosity occurs in a viscosity characteristic and thus the ejection stability of the ink from the ink jet head deteriorates.

The ink composition of the invention may include various additives such as a moisturizing agent, a solubilization auxiliary agent, a penetration controlling agent, a viscosity modifier, a pH adjuster, a solubilization auxiliary agent, an antioxidizing agent, an antiseptic agent, a fungicide, a corrosion inhibitor, a chelate for capturing a metal ion having an influence on dispersion, and so on, in order to secure the standing stability and the stable ejection from the ink jet head, prevent clogging or prevent ink deterioration.

In addition, the ink composition of the invention is preferably ejected by a method using an electrostriction element in which heating is not performed, such as a piezoelectric element. In the case where heating is performed like a thermal head, the added polymer fine particle or the polymer used in the dispersion of the pigment is modified and thus the ejection is apt to become unstable. In particular, in the case where a large amount of ink is ejected for a long period of time like the textile ink jet ink, the head in which heating occurs is not preferable.

Hereinafter, the examples of the invention will be described in detail. In addition, the invention is not limited to the examples. In addition, the compositions of the following examples, “parts” and “%” indicate “parts by mass” and “mass %”, respectively, unless specially limited.

### EXAMPLES

Hereinafter, an example of Embodiment A containing block isocyanate as the reactant will be described.

### Example A-1

### (1) Manufacture of Pigment Dispersion Element A1

In a pigment dispersion element A1, MONARCH 880 manufactured by Cabot Corporation of United States which is carbon black (pigment black 7) was used. By the same method as Japanese Unexamined Patent Application Publication No. 8-3498, the surface of the carbon black was oxidized so as to be dispersed in water and was used as the dispersion element A1. The particle diameter was measured to 110 nm using a microtrac particle size distribution measuring device UPA250 (manufactured by NIKKISO).

### (2) Manufacture of Polymer Fine Particle

A dripping device, a thermometer, a water cooling type recirculated condenser, and an agitator were included in a reaction vessel, 0.2 parts of potassium peroxodisulfate of a polymeric initiator was added at a nitrogen atmosphere of 70° C. while 100 parts of ion exchange water is inserted and agitated, and a monomer solution obtained by inserting 0.05 parts of sodium lauryl sulfate, 4 parts of glycidoxy acrylate, 15 parts of ethyl acrylate, 15 parts of butyl acrylate, 6 parts of tetrahydrofurfuryl acrylate, 5 parts of butyl methacrylate and 0.02 parts of t-dodecylmercaptane into 7 parts of ion exchange water was dripped at 70° C. to as to cause reaction, thereby manufacturing a primary material. 2 parts of ammonium persulfate 10% solution was added to the primary material and was agitated, a reaction solution including 30 parts of ion exchange water, 0.2 parts of sodium lauryl sulfate, 30 parts of ethyl acrylate, 25 parts of methyl acrylate, 6 parts of butyl acrylate, 5 parts of acrylic acid, and 0.5 parts of t-dodecylmercaptane was additionally added while being agitated at 70° C. so as to cause polymerization reaction, and then neutralization was performed by sodium hydrate to set pH to 8 to 8.5, and a polymer fine particle water dispersion liquid filtered by a 0.3 μm filter was manufactured, thereby obtaining emulsion AA (EM-AA). After a portion of this polymer fine particle water dispersion liquid is dried, the glass transition temperature was measured to −15° C. by a differential scanning calorimeter (EXSTAR6000DSC manufactured by Seiko Instruments Inc.). The styrene-converted molecular weight when a solvent is measured by a THF using a Gel Permeation Chromatography (GPC) of an L7100 system manufactured by Hitachi, Ltd. was 150000. In addition, the acid value by a titration method was 20 mgKOH/g.

### (3) Manufacture of Ink for Ink Jet Recording

Hereinafter, an example of a composition suitable for the ink for ink jet recording is shown in Table 2. The manufacture of the ink for ink jet recording of the invention was performed by mixing of a vehicle component shown in Table 2 using the dispersion element A1 manufactured by the above method. In addition, in the remaining water of Examples, Reference Examples and Comparative Examples according to Embodiment A of the invention, a material obtained by adding 0.05% of Topside 240 (manufactured by Permachem Asia, Ltd.) for corrosion prevention of the ink, 0.02% of benzotriazole for corrosion prevention of the ink jet head member, and 0.04% of EDTA (ethylenediamine tetraacetate).2Na salt for reducing the influence of a metal ion in the ink system to ion exchange water was used.

### (4) Abrasion-Proof Property Test and Dry Cleaning Property Test

Using the ink of Example A-1 and using PX-V600 manufactured by Seiko Epson Corporation as the ink jet printer, cotton cloth was subjected to solid printing so as to prepare a sample and a heating treatment was performed for 5 minutes at 150° C. This sample was subjected to a rubbing fastness test of 200-times rubbing with a load of 300 g using a color fastness rubbing tester AB-301S of TESTER SANGYO CO., LTD. The examination of two levels of drying and wetting were performed by JIS (Japanese Industrial Standards) L0849 for checking peeling condition of the ink. Similarly, the dry cleaning test was evaluated by method B of JIS L0860. The result of the abrasion-proof property test and the dry cleaning test was shown in Table 1.

### (5) Measurement of Ejection Stability

Using PX-V600 manufactured by Seiko Epson Corporation as the ink jet printer, printing was performed with respect to A4-sized XeroxP paper manufactured by Fuji Xerox Co., Ltd. by 100 pages with a ratio of 4000 characters/page with MSP Gothic and the standard of a character size of 11 by Microsoft Word at an atmosphere of 35° C. and 35%, and an evaluation was performed. The result is shown in Table 1 such that a matter without printing disturbance is denoted by AA, a matter with one printing disturbance is denoted by A, a matter with two to three printing disturbances is denoted by B, a matter with four to five printing disturbances is denoted by C, and a matter with six or more printing disturbances is denoted by D.

### Example A-2

### (1) Manufacture of Pigment Dispersion Element A2

First, in a pigment dispersion element A2, pigment blue 15:3 (copper phthalocyanine pigment: manufactured by Clariant) was used. Nitrogen substitution was performed with respect to a reaction vessel including an agitator, a thermometer, a recirculated pipe and a dripping funnel, and then 75 parts of benzyl acrylate, 2 parts of acrylic acid, 0.3 parts of t-dodecylmercaptane were inserted, heating was performed to 70° C., 150 parts of benzyl acrylate, 15 parts of acrylic acid, 5 parts of butyl acrylate, 1 part of t-dodecylmercaptane, 20 parts of methyl ethyl ketone and 1 part of sodium persulfate, which are separately prepared, were inserted into the dripping funnel and were dripped to the reaction vessel for four hours, such that a dispersion polymer was subjected to polymerization reaction. Next, methyl ethyl ketone was added to the reaction vessel so as to manufacture a dispersion polymer solution having a concentration of 40%. After a portion of this polymer is dried, the glass transition temperature was measured to 40° C. by a differential scanning calorimeter (EXSTAR6000DSC manufactured by Seiko Instruments Inc.).

In addition, 40 parts of dispersion polymer solution, 30 parts of pigment blue 15:3, 100 parts of a 0.1 mol/L aqueous sodium hydroxide solution, and 30 parts of methyl ethyl ketone were mixed. Thereafter, dispersion was performed by 15 passes with 200 MPa using an ultrahigh-pressure homogenizer (an ultimizer HJP-25005 (manufactured by SUGINO MACHINE LIMITED)). Thereafter, this was transferred to another vessel, 300 parts of ion exchange water was added, and agitation was performed for one hour. In addition, the total amount of methyl ethyl ketone and a portion of water were distilled using a rotary evaporator, and neutralization was performed by 0.1 mol/L sodium hydrate to set pH to 9. Thereafter, filtering was performed by a 0.3 μm membrane filter, adjustment was performed with ion exchange water, and a pigment dispersion element A2 having a pigment concentration of 15% was obtained. The particle diameter was measured to 80 nm by the same method as of Example A-1.

### (2) Manufacture of Polymer Fine Particle

A dripping device, a thermometer, a water cooling type recirculated condenser, and an agitator were included in a reaction vessel, 0.2 parts of potassium peroxodisulfate of a polymeric initiator was added at a nitrogen atmosphere of 70° C. while 100 parts of ion exchange water is inserted and agitated, and a monomer solution obtained by inserting 0.05 parts of sodium lauryl sulfate, 19 parts of ethyl acrylate, 15 parts of butyl acrylate, 6 parts of tetrahydrofurfuryl acrylate, 5 parts of butyl methacrylate and 0.02 parts of t-dodecylmercaptane into 7 parts of ion exchange water was dripped at 70° C. to as to cause reaction, thereby manufacturing a primary material. 2 parts of ammonium persulfate 10% solution was added to the primary material and was agitated, a reaction solution including 30 parts of ion exchange water, 0.2 parts of sodium lauryl sulfate, 30 parts of ethyl acrylate, 25 parts of methyl acrylate, 16 parts of butyl acrylate, 5 parts of acrylic acid, and 0.5 parts of t-dodecylmercaptane was additionally added while being agitated at 70° C. so as to cause polymerization reaction, and neutralization was performed by sodium hydrate to set pH to 8 to 8.5, and a polymer fine particle water dispersion liquid filtered by a 0.3 μm filter was manufactured, thereby obtaining emulsion AB (EM-AB). After a portion of this polymer fine particle water dispersion liquid is dried, the glass transition temperature was measured to −17° C. by a differential scanning calorimeter (EXSTAR6000DSC manufactured by Seiko Instruments Inc.). The molecular weight was measured to 200000 by the same method as Example A-1. In addition, the acid value by a titration method was 20 mgKOH/g.

### (3) Manufacture of Ink for Ink Jet Recording

Hereinafter, an example of a composition suitable for the ink for ink jet recording is shown in Table 2. The manufacture of the ink for ink jet recording of the invention was performed by mixing of a vehicle component shown in Table 2 using the dispersion element A2 manufactured by the above method, similar to Example A-1.

### (4) Abrasion-Proof Property Test and Dry Cleaning Property Test

Using the ink of Example A-2, the abrasion-proof property test and the dry cleaning test were performed by the same method and the same evaluation method as Example A-1. The result of the abrasion-proof property test and the dry cleaning test was shown in Table 1.

### (5) Measurement of Ejection Stability

Using the ink of Example A-2, the measurement of the ejection stability was performed by the same method and the same evaluation method as Example A-1. The measured result of the ejection stability is shown in Table 1.

### Example A-3

### (1) Manufacture of Pigment Dispersion Element A3

First, a pigment dispersion element A3 was manufactured using pigment violet 19 (quinacridone pigment: manufactured by Clariant), similar to the pigment dispersion element A2. The particle diameter was measured to 90 nm by the same method as Example A-1.

### (2) Manufacture of Polymer Fine Particle

The same polymer fine particle as Example A-2 was used.

### (3) Manufacture of Ink for Ink Jet Recording

Hereinafter, an example of a composition suitable for the ink for ink jet recording is shown in Table 2. The manufacture of the ink for ink jet recording of the invention was performed by mixing of a vehicle component shown in Table 2 using the dispersion element A3 manufactured by the above method and was evaluated, similar to Example A-1.

### (4) Abrasion-Proof Property Test and Dry Cleaning Property Test

Using the ink of Example A-3, the abrasion-proof property test and the dry cleaning property test were performed by the same method and the same evaluation method as Example A-1. The result of the abrasion-proof property test and the dry cleaning test was shown in Table 1.

### (5) Measurement of Ejection Stability

Using the ink of Example A-3, the measurement of the ejection stability was performed by the same method and the same evaluation method as Example A-1. The measured result of the ejection stability is shown in Table 1.

### Example A-4

### (1) Manufacture of Pigment Dispersion Element A4

First, a pigment dispersion element A4 was manufactured using pigment yellow 14 (azo pigment: manufactured by Clariant), similar to the pigment dispersion element A2. The particle diameter was measured to 115 nm by the same method as Example A-1.

### (2) Manufacture of Polymer Fine Particle

The same polymer fine particle as Example A-2 was used.

### (3) Manufacture of Ink for Ink Jet Recording

Hereinafter, an example of a composition suitable for the ink for ink jet recording is shown in Table 2. The manufacture of the ink for ink jet recording of the invention was performed by mixing of a vehicle component shown in Table 2 using the dispersion element A4 manufactured by the above method and was evaluated, similar to Example A-1.

### (4) Abrasion-Proof Property Test and Dry Cleaning Property Test

Using the ink of Example A-4, the abrasion-proof property test and the dry cleaning property test were performed by the same method and the same evaluation method as Example A-1. The result of the abrasion-proof property test and the dry cleaning test was shown in Table 1.

### (5) Measurement of Ejection Stability

Using the ink of Example A-4, the measurement of the ejection stability was performed by the same method and the same evaluation method as Example A-1. The measured result of the ejection stability is shown in Table 1.

### Comparative Example A-1

In Comparative Example A-1, except that the total amount (45 parts) of ethyl acrylate is changed to 45 parts of benzyl methacrylate and a polymer fine particle having a glass transition temperature of 0° C. was used, the ink was manufactured similar to Example A-1 and was evaluated. Emulsion manufactured using this polymer fine particle was set to emulsion AC (EM-AC). The ink composition is shown in Table 2. The abrasion-proof property test, the dry cleaning property test and the ejection stability test were performed similar to Example A-1. The result is shown in Table 1.

### Comparative Example A-2

In Comparative Example A-2, except that the total amount (49 parts) of ethyl acrylate is substituted to benzyl methacrylate, 10 parts of butyl acrylate is changed to 10 parts of benzyl methacrylate and a polymer fine particle having a glass transition temperature of 10° C. was used, the ink was manufactured similar to Example A-2 and was evaluated. Emulsion manufactured using this polymer fine particle was set to emulsion AD (EM-AD). The ink composition is shown in Table 2. The abrasion-proof property test, the dry cleaning property test and the ejection stability test were performed similar to Example A-1. The result is shown in Table 1.

### Comparative Example A-3

In Comparative Example A-3, except that dispersion elements in which the particle diameter of a pigment is 350 nm and 45 nm were prepared, the ink was manufactured similar to Example A-3 and was evaluated. The particle diameter was measured by the same method as Example A-1. The dispersion element having the particle diameter of 350 nm was set to a pigment dispersion element A3A and a dispersion element having the particle diameter of 45 nm was set to a pigment dispersion element A3B. The ink composition is shown in Table 2. The abrasion-proof property test, the dry cleaning property test and the ejection stability test were performed similar to Example A-1. The result is shown in Table 1.

### Comparative Example A-4

In Comparative Example A-4, except that the acid value of the added polymer fine particle is 120 mgKOH/g and 150 mgKOH/g, the ink was manufactured similar to Example A-4 and was evaluated. Emulsion manufactured using the polymer fine particle having the acid value 120 mgKOH/g was set to emulsion AE (EM-AE) and emulsion manufactured using the polymer fine particle having the acid value 150 mgKOH/g was set to emulsion AF (EM-AF). The ink composition is shown in Table 2. The abrasion-proof property test, the dry cleaning property test and the ejection stability test were performed similar to Example A-1. The result is shown in Table 1.

### Comparative Example A-5

In Comparative Example A-5, except that the block isocyanate (NKLinkerBX manufactured by SHIN-NAKAMURA CHEMICAL CO., LTD.) is not used, the ink was manufactured similar to Example A-2 and was evaluated. The ink composition is shown in Table 2. The abrasion-proof property test, the dry cleaning property test and the ejection stability test were performed similar to Example A-1. The result is shown in Table 1.

### Comparative Example A-6

In Comparative Example A-6, except that the block isocyanate (NKLinkerBX manufactured by SHIN-NAKAMURA CHEMICAL CO., LTD.) is not used, the ink was manufactured similar to Example A-3 and was evaluated. The ink composition is shown in Table 2. The abrasion-proof property test, the dry cleaning property test and the ejection stability test were performed similar to Example A-1. The result is shown in Table 1.

[Table 1]

TABLE 1
Result of Abrasion-Proof Property, Dry
Cleaning Property and Ejection Stability of Examples A-1 to
4 and Comparative Examples A-1 to 6

| | | | | Abrasion-proof | | | |
|---|---|---|---|---|---|---|---|
| | | Particle | | property | | | |
| | | diam- | Acid | | Wet- | Dry | Ejection |
| | Tg | eter | value | Drying | ting | cleaning | stability |
| Example A-1 | −15 | 110 | 20 | ¾ | ¾ | ⅘ | A |
| Example A-2 | −17 | 80 | 20 | 5 | ⅘ | 5 | A |
| Example A-3 | −17 | 90 | 20 | 5 | 5 | 5 | A |
| Example A-4 | −17 | 115 | 20 | 5 | 5 | 5 | A |
| Comparative | 0 | 110 | 20 | 3 | 2 | ⅔ | A |
| example A-1 | | | | | | | |
| Comparative | 10 | 80 | 20 | ⅔ | ⅔ | 2 | A |
| example A-2 | | | | | | | |
| Comparative | −17 | 350 | 20 | 2 | 2 | ⅔ | D |
| example A-3 | −17 | 45 | 20 | ¾ | ¾ | 4 | C |
| Comparative | −17 | 115 | 120 | 3 | 3 | 3 | A |
| example A-4 | −17 | 115 | 150 | ⅔ | ⅔ | ¾ | B |
| Comparative | −17 | 80 | 20 | 2 | ½ | 5 | A |
| example A-5 | | | | | | | |
| Comparative | −17 | 90 | 20 | 3 | ⅔ | 5 | A |
| example A-6 | | | | | | | |

The unit of Tg is ° C., the particle diameter is the average particle diameter of the pigment and the unit thereof is nm, and the unit of the acid value is mgKOH/g.
The abrasion-proof property and the dry cleaning property follow the evaluation reference of JIS.

[Table 2]

TABLE 2
Ink Composition (mass %) of Examples A-1 to 4
and Comparative Examples A-1 to 6

| | Example | | | | Comparative example | | | | | | | |
|---|---|---|---|---|---|---|---|---|---|---|---|---|
| | A-1 | A-2 | A-3 | A-4 | A-1 | A-2 | A-3 | | A-4 | | A-5 | A-6 |
| Dispersion | 4.5 | — | — | — | 4.5 | — | — | — | — | — | — | — |
| Element A1 | | | | | | | | | | | | |
| Dispersion | — | 3.5 | — | — | — | 3.5 | — | — | — | — | 3.5 | — |
| Element A2 | | | | | | | | | | | | |
| Dispersion | — | — | 4.5 | — | — | — | — | — | — | — | — | 4.5 |
| Element A3 | | | | | | | | | | | | |
| Dispersion | — | — | — | 4.5 | — | — | — | — | 4.5 | 4.5 | — | — |
| Element A4 | | | | | | | | | | | | |
| Dispersion | — | — | — | — | — | — | 4.5 | — | — | — | — | — |
| Element | | | | | | | | | | | | |
| A3A | | | | | | | | | | | | |
| Dispersion | — | — | — | — | — | — | — | 4.5 | — | — | — | — |
| Element | | | | | | | | | | | | |
| A3B | | | | | | | | | | | | |
| EM-AA | 6.0 | — | — | — | — | — | — | — | — | — | — | — |
| EM-AB | — | 5.0 | 6.0 | 6.0 | — | — | 6.0 | 6.0 | — | — | 5.0 | 6.0 |
| EM-AC | — | — | — | — | 6.0 | — | — | — | — | — | — | — |
| EM-AD | — | — | — | — | — | 6.0 | — | — | — | — | — | — |
| EM-AE | — | — | — | — | — | — | — | — | 6.0 | — | — | — |
| EM-AF | — | — | — | — | — | — | — | — | — | 6.0 | — | — |
| NKLinkerBX | 2.0 | 3.0 | 3.0 | 2.0 | 2.0 | 3.0 | 3.0 | 3.0 | 2.0 | 2.0 | — | — |
| 1,2-HD | 2.0 | 3.0 | 3.0 | 2.0 | 2.0 | 3.0 | 3.0 | 3.0 | 2.0 | 2.0 | 3.0 | 3.0 |
| 1,2-PD | — | — | — | 1.0 | — | — | — | — | 1.0 | 1.0 | — | — |
| TEGmBE | 2.0 | 1.0 | 1.0 | 2.0 | 2.0 | 1.0 | 1.0 | 1.0 | 2.0 | 2.0 | 1.0 | 1.0 |
| S-104 | 0.3 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.5 | 0.5 | 0.3 |
| S-61 | — | — | 0.2 | — | — | — | 0.2 | 0.2 | — | — | — | 0.2 |
| Glycerin | 10.0 | 12.0 | 10.0 | 10.0 | 10.0 | 12.0 | 10.0 | 10.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 | 5.0 | 4.0 |
| 2-P | 1.0 | — | — | — | 1.0 | — | — | — | — | — | — | — |
| TEA | 1.0 | 1.0 | 1.0 | 1.0 | 1.0 | 1.0 | 1.0 | 1.0 | 1.0 | 1.0 | 1.0 | 1.0 |
| Ion | Re- | Re- | Re- | Re- | Re- | Re- | Re- | Re- | Re- | Re- | Re- | Re- |
| exchange | sidual | sidual | sidual | sidual | sidual | sidual | sidual | sidual | sidual | sidual | sidual | sidual |
| water | amount | amount | amount | amount | amount | amount | amount | amount | amount | amount | amount | amount |

The concentrations of the pigment and the polymer are denoted by solid content.
NKLinkerBX Block isocyanate emulsion manufactured by SHIN-NAKAMURA CHEMICAL CO., LTD.
1,2-HD 1,2-hexanediol
1,2-PD 1,2-pentanediol
TEGmBE triethylene glycol monobutyl ether S-104 Surfynol 104 (surfactant of acetylene glycol manufactured by NISSIN CHEMICAL INDUSTRY CO., LTD.)
S-465 Surfynol 465 (surfactant of acetylene glycol manufactured by NISSIN CHEMICAL INDUSTRY CO., LTD.)
S-61 Surfynol 61 (surfactant of acetylene alcohol manufactured by NISSIN CHEMICAL INDUSTRY CO., LTD.)
TMP trimethylolpropane
TEG triethylene glycol
2-P 2-pyrolidone
TEA triethanolamine

### Example A-5

### (1) Manufacture of Pigment Dispersion Element A5

In a pigment dispersion element A5, MA100 manufactured by Mitsubishi Chemical Corporation which is carbon black (PBk7) was used. The surface of the carbon black was oxidized by the same method as Japanese Unexamined Patent Application Publication No. 8-3498 so as to be dispersed in water and the dispersion element A5 was obtained. The particle diameter was measured to 120 nm by the same method as Example A-1.

### (2) Manufacture of Polymer Fine Particle

A dripping device, a thermometer, a water cooling type recirculated condenser, and an agitator were included in a reaction vessel, 0.3 parts of potassium peroxodisulfate of a polymeric initiator was added at a nitrogen atmosphere of 70° C. while 100 parts of ion exchange water is inserted and agitated, and a monomer solution obtained by inserting 0.05 parts of sodium lauryl sulfate, 20 parts of ethyl acrylate, 15 parts of butyl acrylate, 6 parts of lauryl acrylate, 5 parts of butyl methacrylate and 0.02 parts of t-dodecylmercaptane into 7 parts of ion exchange water was dripped at 70° C. to as to cause reaction, thereby manufacturing a primary material. 2 parts of ammonium persulfate 10% solution was added to the primary material and was agitated, a reaction solution including 30 parts of ion exchange water, 0.2 parts of sodium lauryl sulfate, 30 parts of ethyl acrylate, 25 parts of butyl acrylate, 16 parts of lauryl acrylate, 5 parts of acrylic acid, and 0.5 parts of t-dodecylmercaptane was additionally added while being agitated at 70° C. so as to cause polymerization reaction, and neutralization was performed by sodium hydrate to set pH to 8 to 8.5, and a polymer fine particle water dispersion liquid filtered by a 0.3 μm filter was prepared, thereby obtaining emulsion AI (EM-AI). After a portion of this polymer fine particle water dispersion liquid is dried, the glass transition temperature was measured to −19° C. by a differential scanning calorimeter (EXSTAR6000DSC manufactured by Seiko Instruments Inc.). The molecular weight was measured to 180000 by the same method as Example A-1. In addition, the acid value by a titration method was 18 mgKOH/g.

### (3) Manufacture of Ink for Ink Jet Recording

Hereinafter, an example of a composition suitable for the ink for ink jet recording is shown in Table 4. The manufacture of the ink for ink jet recording of the invention was performed by mixing of a vehicle component shown in Table 4 using the dispersion element A5 manufactured by the above method, similar to Example A-1.

### (4) Abrasion-Proof Property Test and Dry Cleaning Property Test

Using the ink of Example A-5, the abrasion-proof property test and the dry cleaning property test were performed by the same method and the same evaluation method as Example A-1. The result of the abrasion-proof property test and the dry cleaning test was shown in Table 3.

### (5) Measurement of Ejection Stability

Using the ink of Example A-5, the measurement of the ejection stability was performed by the same method and the same evaluation method as Example A-1. The measured result of the ejection stability is shown in Table 3.

### Example A-6

### (1) Manufacture of Pigment Dispersion Element A6

First, in a pigment dispersion element A6, pigment blue 15:3 (copper phthalocyanine pigment: manufactured by Clariant) was used. Nitrogen substitution was performed with respect to a reaction vessel including an agitator, a thermometer, a recirculated pipe and a dripping funnel, 45 parts of styrene, 30 parts of polyethylene glycol 400 acrylate, 10 parts of benzyl acrylate, 2 parts of acrylic acid, 0.3 parts of t-dodecylmercaptane were inserted, heating was performed to 70° C., 150 parts of styrene, 100 parts of polyethylene glycol 400 acrylate, 15 parts of acrylic acid, 5 parts of butyl acrylate, 1 part of t-dodecylmercaptane, 5 parts of sodium persulfate, which are separately prepared, were inserted into the dripping funnel and were dripped to the reaction vessel for four hours, such that a dispersion polymer was subjected to polymerization reaction. Next, water was added to the reaction vessel so as to prepare a dispersion polymer solution having a concentration of 40%. After a portion of this polymer is dried, the glass transition temperature was measured to 45° C. by a differential scanning calorimeter (EXSTAR6000DSC manufactured by Seiko Instruments Inc.).

In addition, 40 parts of dispersion polymer solution, 30 parts of pigment blue 15:3, and 100 parts of a 0.1 mol/L aqueous sodium hydroxide solution were mixed, and dispersion was performed using an Eiger mill using zirconia beads for two hours. Thereafter, this was transferred to another vessel, and 300 parts of ion exchange water was added, and agitation was performed for one hour. In addition, neutralization was performed by 0.1 mol/L sodium hydrate to set pH to 9. Thereafter, filtering was performed by a 0.3 μm membrane filter, and a pigment dispersion element A6 having a solid content (dispersion polymer and pigment blue is 15:3) of 20% was obtained. The particle diameter was measured to 100 nm by the same method as Example A-1. The molecular weight was measured to 210000 by the same method as Example A-1.

### (2) Manufacture of Polymer Fine Particle

A dripping device, a thermometer, a water cooling type recirculated condenser, and an agitator were included in a reaction vessel, 0.3 parts of potassium peroxodisulfate of a polymeric initiator was added at a nitrogen atmosphere of 70° C. while 100 parts of ion exchange water is inserted and agitated, and a monomer solution obtained by inserting 0.05 parts of sodium lauryl sulfate, 20 parts of ethyl acrylate, 25 parts of butyl acrylate, 6 parts of lauryl acrylate, 5 parts of butyl methacrylate and 0.02 parts of t-dodecylmercaptane into 7 parts of ion exchange water was dripped at 70° C. to as to cause reaction, thereby manufacturing a primary material. 2 parts of ammonium persulfate 10% solution was added to the primary material and was agitated, a reaction solution including 30 parts of ion exchange water, 0.2 parts of sodium lauryl sulfate, 20 parts of ethyl acrylate, 20 parts of butyl acrylate, 20 parts of lauryl acrylate, 5 parts of acrylic acid, and 0.5 parts of t-dodecylmercaptane was additionally added while being agitated at 70° C. so as to cause polymerization reaction, and neutralization was performed by sodium hydrate to set pH to 8 to 8.5, and a polymer fine particle water dispersion liquid filtered by a 0.3 μm filter was prepared, thereby obtaining emulsion AJ (EM-AJ). After a portion of this polymer fine particle water dispersion liquid is dried, the glass transition temperature was measured to −21° C. by a differential scanning calorimeter (EXSTAR6000DSC manufactured by Seiko Instruments Inc.). In addition, the acid value by a titration method was 18 mgKOH/g.

### (3) Manufacture of Ink for Ink Jet Recording

Hereinafter, an example of a composition suitable for the ink for ink jet recording is shown in Table 4. The manufacture of the ink for ink jet recording of the invention was performed by mixing of a vehicle component shown in Table 4 using the dispersion element A6 manufactured by the above method, similar to Example A-1.

### (4) Abrasion-Proof Property Test and Dry Cleaning Property Test

Using the ink of Example A-6, the abrasion-proof property test and the dry cleaning property test were performed by the same method and the same evaluation method as Example A-1. The result of the abrasion-proof property test and the dry cleaning test was shown in Table 3.

### (5) Measurement of Ejection Stability

Using the ink of Example A-6, the measurement of the ejection stability was performed by the same method and the same evaluation method as Example A-1. The measured result of the ejection stability is shown in Table 3.

### Example A-7

### (1) Manufacture of Pigment Dispersion Element A7

First, a pigment dispersion element A7 was manufactured using pigment red 122 (dimethylquinacridone pigment: manufactured by Clariant), similar to the pigment dispersion element A6. The particle diameter was measured to 80 nm by the same method as Example A-1.

### (2) Manufacture of Polymer Fine Particle

The same polymer fine particle as Example A-6 was used.

### (3) Manufacture of Ink for Ink Jet Recording

Hereinafter, an example of a composition suitable for the ink for ink jet recording is shown in Table 4. The manufacture of the ink for ink jet recording of the invention was performed by mixing of a vehicle component shown in Table 4 using the dispersion element A7 manufactured by the above method and was evaluated, similar to Example A-1.

### (4) Abrasion-Proof Property Test and Dry Cleaning Property Test

The abrasion-proof property test and the dry cleaning property test were performed using the ink of Example A-7 by the same method and the same evaluation method as Example A-1. The result of the abrasion-proof property test and the dry cleaning test was shown in Table 3.

### (5) Measurement of Ejection Stability

Using the ink of Example A-7, the measurement of the ejection stability was performed by the same method and the same evaluation method as Example A-1. The measured result of the ejection stability is shown in Table 3.

### Example A-8

### (1) Manufacture of Pigment Dispersion Element A8

First, a pigment dispersion element A8 was manufactured using pigment yellow 180 (benzimidazolone diazo pigment: manufactured by Clariant), similar to the pigment dispersion element A6. The particle diameter was measured to 130 nm by the same method as Example A-1.

### (2) Manufacture of Polymer Fine Particle

The same polymer fine particle as Example A-6 was used.

### (3) Manufacture of Ink for Ink Jet Recording

Hereinafter, an example of a composition suitable for the ink for ink jet recording is shown in Table 4. The manufacture of the ink for ink jet recording of the invention was performed by mixing of a vehicle component shown in Table 4 using the dispersion element A6 manufactured by the above method and was evaluated, similar to Example A-1.

### (4) Abrasion-Proof Property Test and Dry Cleaning Property Test

Using the ink of Example A-8, the abrasion-proof property test and the dry cleaning property test were performed by the same method and the same evaluation method as Example A-1. The result of the abrasion-proof property test and the dry cleaning test was shown in Table 3.

### (5) Measurement of Ejection Stability

Using the ink of Example A-8, the measurement of the ejection stability was performed by the same method and the same evaluation method as Example A-1. The measured result of the ejection stability is shown in Table 3.

### Reference Example A-7

In Reference Example A-7, except that the molecular weight of the added polymer fine particle is 90000 and 1100000, the ink was manufactured similar to Example A-5 and was evaluated. Emulsion having a molecular weight of 90000 was set to emulsion AK (EM-AK) and emulsion having a molecular weight of 1100000 was set to emulsion AL (EM-AL). The ink composition is shown in Table 4. The abrasion-proof property test, the dry cleaning property test and the ejection stability test were performed similar to Example A-5. The result is shown in Table 3. The measurement of the particle diameter of the polymer fine particle was performed by the same method as Example A-1.

### Reference Example A-8

In Reference Example A-8, except that 1,2-hexanediol as 1,2-alkyleneglycol is substituted by glycerine, the ink was manufactured similar to Example A-6 and was evaluated. The ink composition is shown in Table 4. The abrasion-proof property test, the dry cleaning property test and the ejection stability test were performed similar to Example A-5. The result is shown in Table 3.

### Reference Example A-9

In Reference Example A-9, except that the surfactant of acetylene glycol and the surfactant of acetylene alcohol are substituted by glycerine, the ink was manufactured similar to Example A-7 and was evaluated. The ink composition is shown in Table 4. The abrasion-proof property test, the dry cleaning property test and the ejection stability test were performed similar to Example A-5. The result is shown in Table 3.

### Reference Example A-10

In Reference Example A-10, except that the amount of added polymer fine particle is set to 80% and 50% in a ratio based on the pigment, the ink was manufactured similar to Example A-8 and was evaluated. The ink composition is shown in Table 4. The abrasion-proof property test, the dry cleaning property test and the ejection stability test were performed similar to Example A-5. The result is shown in Table 3.

### Reference Examples A-11 to 15

In Reference Examples A-11 to 15, except that a sample in which cotton cloth was subjected to solid printing is prepared and the condition that a heating treatment was performed for 5 minutes at 150° C. is variously changed, the abrasion-proof property test was evaluated similar to Example A-6. For comparison with Example A-6, the variously changed conditions are set to Reference Examples A-11 to 15, and the results are shown in Table 5.

[Table 3]

TABLE 3
Result of Abrasion-Proof Property, Dry
Cleaning Property and Ejection Stability of Examples A-5 to
8 and Reference Examples A-7 to 10

| | | | | | Ratio | | | | |
|---|---|---|---|---|---|---|---|---|---|
| | | | | | based | Abrasion-proof | | | |
| | | Particle | Acid | Molecular | on | property | | Dry | Ejection |
| | Tg | diameter | value | weight | pigment | Drying | Wetting | cleaning | stability |
| Example A-5 | −19 | 120 | 1.8 | 1.8 | 120 | 4 | 4 | 5 | A |
| Example A-6 | −21 | 100 | 18 | 2.0 | 150 | 5 | 5 | 5 | A |
| Example A-7 | −21 | 80 | 18 | 2.0 | 100 | 5 | 5 | 5 | A |
| Example A-8 | −21 | 130 | 18 | 2.0 | 120 | 5 | 5 | 5 | A |
| Reference | −19 | 120 | 18 | 0.9 | 120 | 3 | 3 | 2 | A |
| example A-7 | −19 | 120 | 18 | 11.0 | 120 | 3 | ⅔ | 3 | D |
| Reference | −21 | 100 | 18 | 2.0 | 150 | 5 | ⅘ | 5 | C |
| example A-8 | | | | | | | | | |
| Reference | −21 | 80 | 18 | 2.0 | 100 | ⅘ | ⅘ | 5 | C |
| example A-9 | | | | | | | | | |
| Reference | −21 | 130 | 18 | 2.0 | 80 | ¾ | ¾ | 3 | A |
| example A-10 | −21 | 130 | 18 | 2.0 | 50 | ⅔ | ⅔ | 2 | A |

The unit of Tg is ° C., the particle diameter is the average particle diameter of the pigment and the unit thereof is nm, and the unit of the acid value is mgKOH/g.
The molecular weight of Table 3 is ×10⁵.
The ratio based on the pigment is denoted by % of the polymer fine particle to the pigment.
The abrasion-proof property and the dry cleaning property follow the evaluation reference of JIS.

[Table 4]

TABLE 4
Ink Composition (mass %) of Examples A-5 to 8
and Reference Examples A-7 to 10

| | Example | | | | Reference example | | | | | |
|---|---|---|---|---|---|---|---|---|---|---|
| | A-5 | A-6 | A-7 | A-8 | A-7 | | A-8 | A-9 | A-10 | |
| Dispersion | 4.0 | — | — | — | 4.0 | 4.0 | — | — | — | — |
| Element | | | | | | | | | | |
| A5 | | | | | | | | | | |
| Dispersion | — | 3.2 | — | — | — | — | 3.2 | — | — | — |
| Element | | | | | | | | | | |
| A6 | | | | | | | | | | |
| Dispersion | — | — | 4.0 | — | — | — | — | 4.0 | — | — |
| Element | | | | | | | | | | |
| A7 | | | | | | | | | | |
| Dispersion | — | — | — | 4.0 | — | — | — | — | 4.0 | 4.0 |
| Element | | | | | | | | | | |
| A8 | | | | | | | | | | |
| EM-AI | 5.0 | — | — | — | — | — | — | — | — | — |
| EM-AJ | — | 4.8 | 4.0 | 5.0 | — | — | 4.8 | 4.0 | 3.2 | 2 |
| EM-AK | — | — | — | — | 5.0 | — | — | — | — | — |
| EM-AL | — | — | — | — | — | 5.0 | — | — | — | — |
| NKLinkerBX | 2.0 | 3.0 | 3.0 | 2.0 | 2.0 | 2.0 | 3.0 | 3.0 | 2.0 | 2.0 |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerine | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion | Residual | Residual | Residual | Residual | Residual | Residual | Residual | Residual | Residual | Residual |
| exchange | amount | amount | amount | amount | amount | amount | amount | amount | amount | amount |
| water | | | | | | | | | | |

The concentrations of the pigment and the polymer are denoted by solid content.
NKLinkerBX Block isocyanate emulsion manufactured by SHIN-NAKAMURA CHEMICAL CO., LTD.
1,2-HD 1,2-hexanediol
1,2-PD 1,2-pentanediol
TEGmBE triethylene glycol monobutyl ether
S-104 Surfynol 104 (surfactant of acetylene glycol manufactured by NISSIN CHEMICAL INDUSTRY CO., LTD.)
S-465 Surfynol 465 (surfactant of acetylene glycol manufactured by NISSIN CHEMICAL INDUSTRY CO., LTD.)
S-61 Surfynol 61 (surfactant of acetylene alcohol manufactured by NISSIN CHEMICAL INDUSTRY CO., LTD.)
TMP trimethylolpropane
TEG triethylene glycol
2-P 2-pyrolidone
TEA triethanolamine

[Table 5]

TABLE 5
Abrasion-Proof Property Test Result When
Heating Condition is changed in Example A-6

| | | | Abrasion- | | |
|---|---|---|---|---|---|
| | Temperature | Time | proof property | | |
| | (° C.) | (min) | Drying | Wetting | Property |
| Example A-6 | 150 | 5 | 5 | 5 | Normal |
| Reference | 100 | 5 | 3 | 3 | Normal |
| example A-11 | | | | | |
| Reference | 150 | 0.5 | 3 | 3 | Normal |
| example A-12 | | | | | |
| Reference | 210 | 5 | 4 | 4 | Fabric |
| example A-13 | | | | | yellowing |
| Reference | 210 | 1 | 4 | 4 | Fabric |
| example A-14 | | | | | yellowing |
| Reference | 100 | 20 | 3 | 3 | Normal |
| example A-15 | | | | | |

Hereinafter, the examples of Embodiment B including the oxazoline-containing polymer as the reactant are described.

### Example B-1

### (1) Manufacture of Pigment Dispersion Element B1

In a pigment dispersion element B1, MONARCH 880 manufactured by Cabot Corporation of United States which is carbon black (pigment black 7) was used. By the same method as Japanese Unexamined Patent Application Publication No. 8-3498, the surface of the carbon black was oxidized so as to be dispersed in water and was used as the dispersion element B1. The particle diameter was measured to 110 nm using a microtrac particle size distribution measuring device UPA250 (manufactured by NIKKISO).

### (2) Manufacture of Polymer Fine Particle

A dripping device, a thermometer, a water cooling type recirculated condenser, and an agitator were included in a reaction vessel, 0.2 parts of potassium peroxodisulfate of a polymeric initiator was added at a nitrogen atmosphere of 70° C. while 100 parts of ion exchange water is inserted and agitated, and a monomer solution obtained by inserting 0.05 parts of sodium lauryl sulfate, 4 parts of glycidoxy acrylate, 15 parts of ethyl acrylate, 15 parts of butyl acrylate, 6 parts of tetrahydrofurfuryl acrylate, 5 parts of butyl methacrylate and 0.02 parts of t-dodecylmercaptane into 7 parts of ion exchange water was dripped at 70° C. to as to cause reaction, thereby manufacturing a primary material. 2 parts of ammonium persulfate 10% solution was added to the primary material and was agitated, a reaction solution including 30 parts of ion exchange water, 0.2 parts of sodium lauryl sulfate, 30 parts of ethyl acrylate, 25 parts of methyl acrylate, 6 parts of butyl acrylate, 5 parts of acrylic acid, and 0.5 parts of t-dodecylmercaptane was additionally added while being agitated at 70° C. so as to cause polymerization reaction, and then neutralization was performed by sodium hydrate to set pH to 8 to 8.5, and a polymer fine particle water dispersion liquid filtered by a 0.3 μm filter was manufactured, thereby obtaining emulsion BA (EM-BA). After a portion of this polymer fine particle water dispersion liquid is dried, the glass transition temperature was measured to −15° C. by a differential scanning calorimeter (EXSTAR6000DSC manufactured by Seiko Instruments Inc.). The styrene-converted molecular weight when a solvent is measured by a THF using a Gel Permeation Chromatography (GPC) of an L7100 system manufactured by Hitachi, Ltd. was 150000. In addition, the acid value by a titration method was 20 mgKOH/g.

### (3) Manufacture of Ink for Ink Jet Recording

Hereinafter, an example of a composition suitable for the ink for ink jet recording is shown in Table 7. The manufacture of the ink for ink jet recording of the invention was performed by mixing of a vehicle component shown in Table 7 using the dispersion element B1 manufactured by the above method. In addition, in the remaining water of Examples, Reference Examples and Comparative Examples according to Embodiment B of the invention, a material obtained by adding 0.05% of Topside 240 (manufactured by Permachem Asia, Ltd.) for corrosion prevention of the ink, 0.02% of benzotriazole for corrosion prevention of the ink jet head member, and 0.04% of EDTA (ethylenediamine tetraacetate).2Na salt for reducing the influence of a metal ion in the ink system to ion exchange water was used.

### (4) Abrasion-Proof Property Test and Dry Cleaning Property Test

Using the ink of Example B-1 and using PX-V600 manufactured by Seiko Epson Corporation as the ink jet printer, cotton cloth was subjected to solid printing so as to prepare a sample and a heating treatment was performed for 5 minutes at 150° C. This sample was subjected to a rubbing fastness test of 200-times rubbing with a load of 300 g using a color fastness rubbing tester AB-301S of TESTER SANGYO CO., LTD. The examination of two levels of drying and wetting were performed by JIS (Japanese Industrial Standards) L0849 for checking peeling condition of the ink. Similarly, the dry cleaning test was evaluated by method B of JIS L0860. The result of the abrasion-proof property test and the dry cleaning test was shown in Table 6.

### (5) Measurement of Ejection Stability

Using PX-V600 manufactured by Seiko Epson Corporation as the ink jet printer, printing was performed with respect to A4-sized XeroxP paper manufactured by Fuji Xerox Co., Ltd. by 100 pages with a ratio of 4000 characters/page with MSP Gothic and the standard of a character size of 11 by Microsoft Word at an atmosphere of 35° C. and 35%, and an evaluation was performed. The result is shown in Table 6 such that a matter without printing disturbance is denoted by AA, a matter with one printing disturbance is denoted by A, a matter with two to three printing disturbances is denoted by B, a matter with four to five printing disturbances is denoted by C, and a matter with six or more printing disturbances is denoted by D. The result is shown in Table 6.

### Example B-2

### (1) Manufacture of Pigment Dispersion Element B2

First, in a pigment dispersion element B2, pigment blue 15:3 (copper phthalocyanine pigment: manufactured by Clariant) was used. Nitrogen substitution was performed with respect to a reaction vessel including an agitator, a thermometer, a recirculated pipe and a dripping funnel, 75 parts of benzyl acrylate, 2 parts of acrylate, 0.3 parts of t-dodecylmercaptane were inserted, heating was performed to 70° C., 150 parts of benzyl acrylate, 15 parts of acrylic acid, 5 parts of butyl acrylate, 1 part of t-dodecylmercaptane, 20 parts of methyl ethyl ketone and 1 part of sodium persulfate, which are separately prepared, were inserted into the dripping funnel and were dripped to the reaction vessel for four hours, such that a dispersion polymer was subjected to polymerization reaction. Next, methyl ethyl ketone was added to the reaction vessel so as to manufacture a dispersion polymer solution having a concentration of 40%. After a portion of this polymer is dried, the glass transition temperature was measured to 40° C. by a differential scanning calorimeter (EXSTAR6000DSC manufactured by Seiko Instruments Inc.).

In addition, 40 parts of dispersion polymer solution, 30 parts of pigment blue 15:3, 100 parts of a 0.1 mol/L aqueous sodium hydroxide solution, and 30 parts of methyl ethyl ketone were mixed. Thereafter, dispersion was performed by 15 passes with 200 MPa using an ultrahigh-pressure homogenizer (an ultimizer HJP-25005 (manufactured by SUGINO MACHINE LIMITED)). Thereafter, this was transferred to another vessel, and 300 parts of ion exchange water was added, and agitation was performed for one hour. In addition, the total amount of methyl ethyl ketone and a portion of water were distilled using a rotary evaporator, and neutralization was performed by 0.1 mol/L sodium hydrate to set pH to 9. Thereafter, filtering was performed by a 0.3 μm membrane filter, adjustment was performed with ion exchange water, and a pigment dispersion element B2 having a pigment concentration of 15% was obtained. The particle diameter was measured to 80 nm by the same method as of Example B-1.

### (2) Manufacture of Polymer Fine Particle

A dripping device, a thermometer, a water cooling type recirculated condenser, and an agitator were included in a reaction vessel, 0.2 parts of potassium peroxodisulfate of a polymeric initiator was added at a nitrogen atmosphere of 70° C. while 100 parts of ion exchange water is inserted and agitated, and a monomer solution obtained by inserting 0.05 parts of sodium lauryl sulfate, 19 parts of ethyl acrylate, 15 parts of butyl acrylate, 6 parts of tetrahydrofurfuryl acrylate, 5 parts of butyl methacrylate and 0.02 parts of t-dodecylmercaptane into 7 parts of ion exchange water was dripped at 70° C. to as to cause reaction, thereby manufacturing a primary material. 2 parts of ammonium persulfate 10% solution was added to the primary material and was agitated, a reaction solution including 30 parts of ion exchange water, 0.2 parts of sodium lauryl sulfate, 30 parts of ethyl acrylate, 25 parts of methyl acrylate, 16 parts of butyl acrylate, 5 parts of acrylic acid, and 0.5 parts of t-dodecylmercaptane was additionally added while being agitated at 70° C. so as to cause polymerization reaction, and neutralization was performed by sodium hydrate to set pH to 8 to 8.5, and a polymer fine particle water dispersion liquid filtered by a 0.3 μm filter was manufactured, thereby obtaining emulsion BB (EM-BB). After a portion of this polymer fine particle water dispersion liquid is dried, the glass transition temperature was measured to −17° C. by a differential scanning calorimeter (EXSTAR6000DSC manufactured by Seiko Instruments Inc.). The molecular weight was measured to 200000 by the same method as Example B-1. In addition, the acid value by a titration method was 20 mgKOH/g.

### (3) Manufacture of Ink for Ink Jet Recording

Hereinafter, an example of a composition suitable for the ink for ink jet recording is shown in Table 7. The manufacture of the ink for ink jet recording of the invention was performed by mixing of a vehicle component shown in Table 7 using the dispersion element B2 manufactured by the above method, similar to Example B-1.

### (4) Abrasion-Proof Property Test and Dry Cleaning Property Test

Using the ink of Example B-2, the abrasion-proof property test and the dry cleaning property test were performed by the same method and the same evaluation method as Example B-1. The result of the abrasion-proof property test and the dry cleaning test was shown in Table 6.

### (5) Measurement of Ejection Stability

Using the ink of Example B-2, the measurement of the ejection stability was performed by the same method and the same evaluation method as Example B-1. The measured result of the ejection stability is shown in Table 6.

### Example B-3

### (1) Manufacture of Pigment Dispersion Element B3

First, a pigment dispersion element B3 was manufactured using pigment violet 19 (quinacridone pigment: manufactured by Clariant), similar to the pigment dispersion element B2. The particle diameter was measured to 90 nm by the same method as Example B-1.

### (2) Manufacture of Polymer Fine Particle

The same polymer fine particle as Example B-2 was used.

### (3) Manufacture of Ink for Ink Jet Recording

Hereinafter, an example of a composition suitable for the ink for ink jet recording is shown in Table 7. The manufacture of the ink for ink jet recording of the invention was performed by mixing of a vehicle component shown in Table 7 using the dispersion element B3 manufactured by the above method and was evaluated, similar to Example B-1.

### (4) Abrasion-Proof Property Test and Dry Cleaning Property Test

Using the ink of Example B-3, the abrasion-proof property test and the dry cleaning property test were performed by the same method and the same evaluation method as Example B-1. The result of the abrasion-proof property test and the dry cleaning test was shown in Table 6.

### (5) Measurement of Ejection Stability

Using the ink of Example B-3, the measurement of the ejection stability was performed by the same method and the same evaluation method as Example B-1. The measured result of the ejection stability is shown in Table 6.

### Example B-4

### (1) Manufacture of Pigment Dispersion Element B4

First, a pigment dispersion element B4 was manufactured using pigment yellow 14 (azo pigment: manufactured by Clariant), similar to the pigment dispersion element B2. The particle diameter was measured to 115 nm by the same method as Example B-1.

### (2) Manufacture of Polymer Fine Particle

The same polymer fine particle as Example B-2 was used.

### (3) Manufacture of Ink for Ink Jet Recording

Hereinafter, an example of a composition suitable for the ink for ink jet recording is shown in Table 7. The manufacture of the ink for ink jet recording of the invention was performed by mixing of a vehicle component shown in Table 7 using the dispersion element B4 manufactured by the above method and was evaluated, similar to Example B-1.

### (4) Abrasion-Proof Property Test and Dry Cleaning Property Test

Using the ink of Example B-4, the abrasion-proof property test and the dry cleaning property test were performed by the same method and the same evaluation method as Example B-1. The result of the abrasion-proof property test and the dry cleaning test was shown in Table 6.

### (5) Measurement of Ejection Stability

Using the ink of Example B-4, the measurement of the ejection stability was performed by the same method and the same evaluation method as Example B-1. The measured result of the ejection stability is shown in Table 6.

### Comparative Example B-1

In Comparative Example B-1, except that the total amount (45 parts) of ethyl acrylate is changed to 45 parts of benzyl methacrylate and a polymer fine particle having a glass transition temperature of 0° C. was used, the ink was manufactured similar to Example B-1 and was evaluated. Emulsion manufactured using this polymer fine particle was set to emulsion BC (EM-BC). The ink composition is shown in Table 7. The abrasion-proof property test, the dry cleaning property test and the ejection stability test were performed similar to Example B-1. The result is shown in Table 6.

### Comparative Example B-2

In Comparative Example B-2, except that the total amount (49 parts) of ethyl acrylate is substituted to benzyl methacrylate, 10 parts of butyl acrylate is changed to 10 parts of benzyl methacrylate and a polymer fine particle having a glass transition temperature of 10° C. was used, the ink was manufactured similar to Example B-2 and was evaluated. Emulsion manufactured using this polymer fine particle was set to emulsion BD (EM-BD). The ink composition is shown in Table 7. The abrasion-proof property test, the dry cleaning property test and the ejection stability test were performed similar to Example B-1. The result is shown in Table 6.

### Comparative Example B-3

In Comparative Example B-3, except that dispersion elements in which the particle diameter of a pigment is 350 nm and 45 nm were prepared, the ink was manufactured similar to Example B-3 and was evaluated. The particle diameter was measured by the same method as Example B-1. The dispersion element having the particle diameter of 350 nm was set to a pigment dispersion element B3A and a dispersion element having the particle diameter of 45 nm was set to a pigment dispersion element B3B. The ink composition is shown in Table 7. The abrasion-proof property test, the dry cleaning property test and the ejection stability test were performed similar to Example B-1. The result is shown in Table 6.

### Comparative Example B-4

In Comparative Example B-4, except that the acid value of the added polymer fine particle is 120 mgKOH/g and 150 mgKOH/g, the ink was manufactured similar to Example B-4 and was evaluated. Emulsion manufactured using the polymer fine particle having the acid value 120 mgKOH/g was set to emulsion BE (EM-BE) and emulsion manufactured using the polymer fine particle having the acid value 150 mgKOH/g was set to emulsion BF (EM-BF). The ink composition is shown in Table 7. The abrasion-proof property test, the dry cleaning property test and the ejection stability test were performed similar to Example B-1. The result is shown in Table 6.

### Comparative Example B-5

In Comparative Example B-5, except that the oxazoline-containing polymer (NKLinkerFX manufactured by SHIN-NAKAMURA CHEMICAL CO., LTD.) is not used, the ink was manufactured similar to Example B-2 and was evaluated. The ink composition is shown in Table 7. The abrasion-proof property test, the dry cleaning property test and the ejection stability test were performed similar to Example B-1. The result is shown in Table 6.

### Comparative Example B-6

In Comparative Example B-6, except that the oxazoline-containing polymer (NKLinkerFX manufactured by SHIN-NAKAMURA CHEMICAL CO., LTD.) is not used, the ink was manufactured similar to Example B-3 and was evaluated. The ink composition is shown in Table 7. The abrasion-proof property test, the dry cleaning property test and the ejection stability test were performed similar to Example B-1. The result is shown in Table 6.

[Table 6]

TABLE 6
Result of Abrasion-Proof Property, Dry
Cleaning Property and Ejection Stability of Examples B-1 to
4 and Comparative Examples B-1 to 6

| | | | | Abrasion-proof | | | |
|---|---|---|---|---|---|---|---|
| | | Particle | | property | | Dry | |
| | | diam- | Acid | | Wet- | clean- | Ejection |
| | Tg | eter | value | Drying | ting | ing | stability |
| Example B-1 | −15 | 110 | 20 | ¾ | ¾ | ⅘ | A |
| Example B-2 | −17 | 80 | 20 | 5 | ⅘ | 5 | A |
| Example B-3 | −17 | 90 | 20 | 5 | 5 | 5 | A |
| Example B-4 | −17 | 115 | 20 | 5 | 5 | 5 | A |
| Comparative | 0 | 110 | 20 | 3 | 2 | ⅔ | A |
| example B-1 | | | | | | | |
| Comparative | 10 | 80 | 20 | ⅔ | ⅔ | 2 | A |
| example B-2 | | | | | | | |
| Comparative | −17 | 350 | 20 | 2 | 2 | 2/3 | D |
| example B-3 | −17 | 45 | 20 | ¾ | ¾ | 4 | C |
| Comparative | −17 | 115 | 120 | 3 | 3 | 3 | A |
| example B-4 | −17 | 115 | 150 | ⅔ | ⅔ | ¾ | B |
| Comparative | −17 | 80 | 20 | 2 | ½ | 5 | A |
| example B-5 | | | | | | | |
| Comparative | −17 | 90 | 20 | 3 | ⅔ | 5 | A |
| example B-6 | | | | | | | |

The unit of Tg is ° C., the particle diameter is the average particle diameter of the pigment and the unit thereof is nm, and the unit of the acid value is mgKOH/g.
The abrasion-proof property and the dry cleaning property follow the evaluation reference of JIS.

[Table 7]

TABLE 7
Ink Composition (mass %) of Examples B-1 to 4
and Comparative Examples B-1 to 6

| | Example | | | | Comparative example | | | | | | | |
|---|---|---|---|---|---|---|---|---|---|---|---|---|
| | B-1 | B-2 | B-3 | B-4 | B-1 | B-2 | B-3 | | B-4 | | B-5 | B-6 |
| Dispersion | 4.5 | — | — | — | 4.5 | — | — | — | — | — | — | — |
| Element B1 | | | | | | | | | | | | |
| Dispersion | — | 3.5 | — | — | — | 3.5 | — | — | — | — | 3.5 | — |
| Element B2 | | | | | | | | | | | | |
| Dispersion | — | — | 4.5 | — | — | — | — | — | — | — | — | 4.5 |
| Element B3 | | | | | | | | | | | | |
| Dispersion | — | — | — | 4.5 | — | — | — | — | 4.5 | 4.5 | — | — |
| Element B4 | | | | | | | | | | | | |
| Dispersion | — | — | — | — | — | — | 4.5 | — | — | — | — | — |
| Element | | | | | | | | | | | | |
| B3A | | | | | | | | | | | | |
| Dispersion | — | — | — | — | — | — | — | 4.5 | — | — | — | — |
| Element | | | | | | | | | | | | |
| B3B | | | | | | | | | | | | |
| EM-BA | 6.0 | — | — | — | — | — | — | — | — | — | — | — |
| EM-BB | — | 5.0 | 6.0 | 6.0 | — | — | 6.0 | 6.0 | — | — | 5.0 | 6.0 |
| EM-BC | — | — | — | — | 6.0 | — | — | — | — | — | — | — |
| EM-BD | — | — | — | — | — | 6.0 | — | — | — | — | — | — |
| EM-BE | — | — | — | — | — | — | — | — | 6.0 | — | — | — |
| EM-BF | — | — | — | — | — | — | — | — | — | 6.0 | — | — |
| NKLinkerFX | 2.0 | 3.0 | 3.0 | 2.0 | 2.0 | 3.0 | 3.0 | 3.0 | 2.0 | 2.0 | — | — |
| 1,2-HD | 2.0 | 3.0 | 3.0 | 2.0 | 2.0 | 3.0 | 3.0 | 3.0 | 2.0 | 2.0 | 3.0 | 3.0 |
| 1,2-PD | — | — | — | 1.0 | — | — | — | — | 1.0 | 1.0 | — | — |
| TEGmBE | 2.0 | 1.0 | 1.0 | 2.0 | 2.0 | 1.0 | 1.0 | 1.0 | 2.0 | 2.0 | 1.0 | 1.0 |
| S-104 | 0.3 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.5 | 0.5 | 0.3 |
| S-61 | — | — | 0.2 | — | — | — | 0.2 | 0.2 | — | — | — | 0.2 |
| Glycerine | 10.0 | 12.0 | 10.0 | 10.0 | 10.0 | 12.0 | 10.0 | 10.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 | 5.0 | 4.0 |
| 2-P | 1.0 | — | — | — | 1.0 | — | — | — | — | — | — | — |
| TEA | 1.0 | 1.0 | 1.0 | 1.0 | 1.0 | 1.0 | 1.0 | 1.0 | 1.0 | 1.0 | 1.0 | 1.0 |
| Ion | Re- | Re- | Re- | Residual | Residual | Residual | Residual | Residual | Residual | Residual | Residual | Residual |
| exchange | sidual | sidual | sidual | amount | amount | amount | amount | amount | amount | amount | amount | amount |
| water | amount | amount | amount | | | | | | | | | |

The concentrations of the pigment and the polymer are denoted by solid content.
NKLinkerFX Oxazoline-containing polymer emulsion manufactured by SHIN-NAKAMURA CHEMICAL CO., LTD.
1,2-HD 1,2-hexanediol
1,2-PD 1,2-pentanediol
TEGmBE triethylene glycol monobutyl ether
S-104 Surfynol 104 (surfactant of acetylene glycol manufactured by NISSIN CHEMICAL INDUSTRY CO., LTD.)
S-465 Surfynol 465 (surfactant of acetylene glycol manufactured by NISSIN CHEMICAL INDUSTRY CO., LTD.)
S-61 Surfynol 61 (surfactant of acetylene alcohol manufactured by NISSIN CHEMICAL INDUSTRY CO., LTD.)
TMP trimethylolpropane
TEG triethylene glycol
2-P 2-pyrolidone
TEA triethanolamine

### Example B-5

### (1) Manufacture of Pigment Dispersion Element B5

In a pigment dispersion element B5, MA100 manufactured by Mitsubishi Chemical Corporation which is carbon black (PBk7) was used. The surface of the carbon black was oxidized by the same method as Japanese Unexamined Patent Application Publication No. 8-3498 so as to be dispersed in water and the dispersion element B5 was obtained. The particle diameter was measured to 120 nm by the same method as Example B-1.

### (2) Manufacture of Polymer Fine Particle

A dripping device, a thermometer, a water cooling type recirculated condenser, and an agitator were included in a reaction vessel, 0.3 parts of potassium peroxodisulfate of a polymeric initiator was added at a nitrogen atmosphere of 70° C. while 100 parts of ion exchange water is inserted and agitated, and a monomer solution obtained by inserting 0.05 parts of sodium lauryl sulfate, 20 parts of ethyl acrylate, 15 parts of butyl acrylate, 6 parts of lauryl acrylate, 5 parts of butyl methacrylate and 0.02 parts of t-dodecylmercaptane into 7 parts of ion exchange water was dripped at 70° C. to as to cause reaction, thereby manufacturing a primary material. 2 parts of ammonium persulfate 10% solution was added to the primary material and was agitated, a reaction solution including 30 parts of ion exchange water, 0.2 parts of sodium lauryl sulfate, 30 parts of ethyl acrylate, 25 parts of butyl acrylate, 16 parts of lauryl acrylate, 5 parts of acrylic acid, and 0.5 parts of t-dodecylmercaptane was additionally added while being agitated at 70° C. so as to cause polymerization reaction, and neutralization was performed by sodium hydrate to set pH to 8 to 8.5, and a polymer fine particle water dispersion liquid filtered by a 0.3 μm filter was prepared, thereby obtaining emulsion BI (EM-BI). After a portion of this polymer fine particle water dispersion liquid is dried, the glass transition temperature was measured to −19° C. by a differential scanning calorimeter (EXSTAR6000DSC manufactured by Seiko Instruments Inc.). The molecular weight was measured to 180000 by the same method as Example B-1. In addition, the acid value by a titration method was 18 mgKOH/g.

### (3) Manufacture of Ink for Ink Jet Recording

Hereinafter, an example of a composition suitable for the ink for ink jet recording is shown in Table 9. The manufacture of the ink for ink jet recording of the invention was performed by mixing of a vehicle component shown in Table 9 using the dispersion element B5 manufactured by the above method, similar to Example B-1.

### (4) Abrasion-Proof Property Test and Dry Cleaning Property Test

Using the ink of Example B-5, the abrasion-proof property test and the dry cleaning property test were performed by the same method and the same evaluation method as Example B-1. The result of the abrasion-proof property test and the dry cleaning test was shown in Table 8.

### (5) Measurement of Ejection Stability

Using the ink of Example B-5, the measurement of the ejection stability was performed by the same method and the same evaluation method as Example B-1. The measured result of the ejection stability is shown in Table 8.

### Example B-6

### (1) Manufacture of Pigment Dispersion Element B6

First, in a pigment dispersion element B6, pigment blue 15:3 (copper phthalocyanine pigment: manufactured by Clariant) was used. Nitrogen substitution was performed with respect to a reaction vessel including an agitator, a thermometer, a recirculated pipe and a dripping funnel, 45 parts of styrene, 30 parts of polyethylene glycol 400 acrylate, 10 parts of benzyl acrylate, 2 parts of acrylic acid, 0.3 parts of t-dodecylmercaptane were inserted, heating was performed to 70° C., 150 parts of styrene, 100 parts of polyethylene glycol 400 acrylate, 15 parts of acrylic acid, 5 parts of butyl acrylate, 1 part of t-dodecylmercaptane, 5 parts of sodium persulfate, which are separately prepared, were inserted into the dripping funnel and were dripped to the reaction vessel for four hours, such that a dispersion polymer was subjected to polymerization reaction. Next, water was added to the reaction vessel so as to prepare a dispersion polymer solution having a concentration of 40%. After a portion of this polymer is dried, the glass transition temperature was measured to 45° C. by a differential scanning calorimeter (EXSTAR6000DSC manufactured by Seiko Instruments Inc.).

In addition, 40 parts of dispersion polymer solution, 30 parts of pigment blue 15:3, and 100 parts of a 0.1 mol/L aqueous sodium hydroxide solution were mixed, and dispersion was performed using an Eiger mill using zirconia beads for two hours. Thereafter, this was transferred to another vessel, and 300 parts of ion exchange water was added, and agitation was performed for one hour. In addition, neutralization was performed by 0.1 mol/L sodium hydrate to set pH to 9. Thereafter, filtering was performed by a 0.3 μm membrane filter, and a pigment dispersion element B6 having a solid content (dispersion polymer and pigment blue is 15:3) of 20% was obtained. The particle diameter was measured to 100 nm by the same method as Example B-1. The molecular weight was measured to 210000 by the same method as Example B-1.

### (2) Manufacture of Polymer Fine Particle

A dripping device, a thermometer, a water cooling type recirculated condenser, and an agitator were included in a reaction vessel, 0.3 parts of potassium peroxodisulfate of a polymeric initiator was added at a nitrogen atmosphere of 70° C. while 100 parts of ion exchange water is inserted and agitated, and a monomer solution obtained by inserting 0.05 parts of sodium lauryl sulfate, 20 parts of ethyl acrylate, 25 parts of butyl acrylate, 6 parts of lauryl acrylate, 5 parts of butyl methacrylate and 0.02 parts of t-dodecylmercaptane into 7 parts of ion exchange water was dripped at 70° C. to as to cause reaction, thereby manufacturing a primary material. 2 parts of ammonium persulfate 10% solution was added to the primary material and was agitated, a reaction solution including 30 parts of ion exchange water, 0.2 parts of sodium lauryl sulfate, 20 parts of ethyl acrylate, 20 parts of butyl acrylate, 20 parts of lauryl acrylate, 5 parts of acrylic acid, and 0.5 parts of t-dodecylmercaptane was additionally added while being agitated at 70° C. so as to cause polymerization reaction, and then neutralization was performed by sodium hydrate to set pH to 8 to 8.5, and a polymer fine particle water dispersion liquid filtered by a 0.3 μm filter was prepared, thereby obtaining emulsion BJ (EM-BJ). After a portion of this polymer fine particle water dispersion liquid is dried, the glass transition temperature was measured to −21° C. by a differential scanning calorimeter (EXSTAR6000DSC manufactured by Seiko Instruments Inc.). In addition, the acid value by a titration method was 18 mgKOH/g.

### (3) Manufacture of Ink for Ink Jet Recording

Hereinafter, an example of a composition suitable for the ink for ink jet recording is shown in Table 9. The manufacture of the ink for ink jet recording of the invention was performed by mixing of a vehicle component shown in Table 9 using the dispersion element B6 manufactured by the above method, similar to Example B-1.

### (4) Abrasion-Proof Property Test and Dry Cleaning Property Test

Using the ink of Example B-6, the abrasion-proof property test and the dry cleaning property test were performed by the same method and the same evaluation method as Example B-1. The result of the abrasion-proof property test and the dry cleaning test was shown in Table 8.

### (5) Measurement of Ejection Stability

Using the ink of Example B-6, the measurement of the ejection stability was performed by the same method and the same evaluation method as Example B-1. The measured result of the ejection stability is shown in Table 8.

### Example B-7

### (1) Manufacture of Pigment Dispersion Element B7

First, a pigment dispersion element B7 was manufactured using pigment red 122 (dimethylquinacridone pigment: manufactured by Clariant), similar to the pigment dispersion element B6. The particle diameter was measured to 80 nm by the same method as Example B-1.

### (2) Manufacture of Polymer Fine Particle

The same polymer fine particle as Example B-6 was used.

### (3) Manufacture of Ink for Ink Jet Recording

Hereinafter, an example of a composition suitable for the ink for ink jet recording is shown in Table 9. The manufacture of the ink for ink jet recording of the invention was performed by mixing of a vehicle component shown in Table 9 using the dispersion element B7 manufactured by the above method and was evaluated, similar to Example B-1.

### (4) Abrasion-Proof Property Test and Dry Cleaning Property Test

The abrasion-proof property test and the dry cleaning property test were performed using the ink of Example B-7 by the same method and the same evaluation method as Example B-1. The result of the abrasion-proof property test and the dry cleaning test was shown in Table 8.

### (5) Measurement of Ejection Stability

Using the ink of Example B-7, the measurement of the ejection stability was performed by the same method and the same evaluation method as Example B-1. The measured result of the ejection stability is shown in Table 8.

### Example B-8

### (1) Manufacture of Pigment Dispersion Element B8

First, a pigment dispersion element B8 was manufactured using pigment yellow 180 (benzimidazolone diazo pigment: manufactured by Clariant), similar to the pigment dispersion element B6. The particle diameter was measured to 130 nm by the same method as Example B-1.

### (2) Manufacture of Polymer Fine Particle

The same polymer fine particle as Example B-6 was used.

### (3) Manufacture of Ink for Ink Jet Recording

Hereinafter, an example of a composition suitable for the ink for ink jet recording is shown in Table 9. The manufacture of the ink for ink jet recording of the invention was performed by mixing of a vehicle component shown in Table 9 using the dispersion element B8 manufactured by the above method and was evaluated, similar to Example B-1.

### (4) Abrasion-Proof Property Test and Dry Cleaning Property Test

Using the ink of Example B-8, the abrasion-proof property test and the dry cleaning test were performed by the same method and the same evaluation method as Example B-1. The result of the abrasion-proof property test and the dry cleaning test was shown in Table 8.

### (5) Measurement of Ejection Stability

Using the ink of Example B-8, the measurement of the ejection stability was performed by the same method and the same evaluation method as Example B-1. The measured result of the ejection stability is shown in Table 8.

### Reference Example B-7

In Reference Example B-7, except that the molecular weight of the added polymer fine particle is 90000 and 1100000, the ink was manufactured similar to Example B-5 and was evaluated. Emulsion having a molecular weight of 90000 was set to emulsion BK (EM-BK) and emulsion having a molecular weight of 1100000 was set to emulsion BL (EM-BL). The ink composition is shown in Table 9. The abrasion-proof property test, the dry cleaning property test and the ejection stability test were performed similar to Example B-5. The result is shown in Table 8. The measurement of the particle diameter of the polymer fine particle was performed by the same method as Example B-1.

### Reference Example B-8

In Reference Example B-8, except that 1,2-hexanediol as 1,2-alkyleneglycol is substituted by glycerine, the ink was manufactured similar to Example B-6 and was evaluated. The ink composition is shown in Table 9. The abrasion-proof property test, the dry cleaning property test and the ejection stability test were performed similar to Example B-5. The result is shown in Table 8.

### Reference Example B-9

In Reference Example B-9, except that the surfactant of acetylene glycol and the surfactant of acetylene alcohol are substituted by glycerine, the ink was manufactured similar to Example B-7 and was evaluated. The ink composition is shown in Table 9. The abrasion-proof property test, the dry cleaning property test and the ejection stability test were performed similar to Example B-5. The result is shown in Table 8.

### Reference Example B-10

In Reference Example B-10, except that the amount of added polymer fine particle is set to 80% and 50% in a ratio based on the pigment, the ink was manufactured similar to Example B-8 and was evaluated. The ink composition is shown in Table 9. The abrasion-proof property test, the dry cleaning property test and the ejection stability test were performed similar to Example B-5. The result is shown in Table 8.

### Reference Examples B-11 to 15

In Reference Examples B-11 to 15, except that a sample in which cotton cloth was subjected to solid printing is prepared and the condition that a heating treatment was performed for 5 minutes at 150° C. is variously changed, the abrasion-proof property test was evaluated similar to Example B-6. For comparison with Example B-6, the variously changed conditions are set to Reference Examples B-11 to 15, and the results are shown in Table 10.

[Table 8]

TABLE 8
Result of Abrasion-Proof Property, Dry
Cleaning Property and Ejection Stability of Examples B-5 to
8 and Reference Examples B-7 to 10

| | | | | | Ratio | | | | |
|---|---|---|---|---|---|---|---|---|---|
| | | | | | based | Abrasion-proof | | | |
| | | Particle | Acid | Molecular | on | property | | Dry | Ejection |
| | Tg | diameter | value | weight | pigment | Drying | Wetting | cleaning | stability |
| Example B-5 | −19 | 120 | 18 | 1.8 | 120 | 4 | 4 | 5 | A |
| Example B-6 | −21 | 100 | 18 | 2.0 | 150 | 5 | 5 | 5 | A |
| Example B-7 | −21 | 80 | 18 | 2.0 | 100 | 5 | 5 | 5 | A |
| Example B-8 | −21 | 130 | 18 | 2.0 | 120 | 5 | 5 | 5 | A |
| Reference | −19 | 120 | 18 | 0.9 | 120 | 3 | 3 | 2 | A |
| example B-7 | −19 | 120 | 18 | 11.0 | 120 | 3 | ⅔ | 3 | D |
| Reference | −21 | 100 | 18 | 2.0 | 150 | 5 | ⅘ | 5 | C |
| example B-8 | | | | | | | | | |
| Reference | −21 | 80 | 18 | 2.0 | 100 | ⅘ | ⅘ | 5 | C |
| example B-9 | | | | | | | | | |
| Reference | −21 | 130 | 18 | 2.0 | 80 | ¾ | ¾ | 3 | A |
| example B- | −21 | 130 | 18 | 2.0 | 50 | ⅔ | ⅔ | 2 | A |
| 10 | | | | | | | | | |

The unit of Tg is ° C., the particle diameter is the average particle diameter of the pigment and the unit thereof is nm, and the unit of the acid value is mgKOH/g.
The molecular weight of Table 8 is ×10⁵.
The ratio based on the pigment is denoted by % of the polymer fine particle to the pigment.
The abrasion-proof property and the dry cleaning property follow the evaluation reference of JIS.

[Table 9]

TABLE 9
Ink Composition (mass %) of Examples B-5 to 8
and Reference Examples B-7 to 10

| | Example | | | | Reference example | | | | | |
|---|---|---|---|---|---|---|---|---|---|---|
| | B-5 | B-6 | B-7 | B-8 | B-7 | | B-8 | B-9 | B-10 | |
| Dispersion | 4.0 | — | — | — | 4.0 | 4.0 | — | — | — | — |
| Element B5 | | | | | | | | | | |
| Dispersion | — | 3.2 | — | — | — | — | 3.2 | — | — | — |
| Element B6 | | | | | | | | | | |
| Dispersion | — | — | 4.0 | — | — | — | — | 4.0 | — | — |
| Element B7 | | | | | | | | | | |
| Dispersion | — | — | — | 4.0 | — | — | — | — | 4.0 | 4.0 |
| Element B8 | | | | | | | | | | |
| EM-BI | 5.0 | — | — | — | — | — | — | — | — | — |
| EM-BJ | — | 4.8 | 4.0 | 5.0 | — | — | 4.8 | 4.0 | 3.2 | 2 |
| EM-BK | — | — | — | — | 5.0 | — | — | — | — | — |
| EM-BL | — | — | — | — | — | 5.0 | — | — | — | — |
| EPOCROS | 2.0 | 3.0 | 3.0 | 2.0 | 2.0 | 2.0 | 3.0 | 3.0 | 2.0 | 2.0 |
| K-2020 | | | | | | | | | | |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerine | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion | Residual | Residual | Residual | Residual | Residual | Residual | Residual | Residual | Residual | Residual |
| exchange | amount | amount | amount | amount | amount | amount | amount | amount | amount | amount |
| water | | | | | | | | | | |

The concentrations of the pigment and the polymer are denoted by solid content.
EPOCROS K-2020 Oxazoline-containing polymer emulsion manufactured by NIPPON SHOKUBAI CO., LTD.
1,2-HD 1,2-hexanediol
1,2-PD 1,2-pentanediol
TEGmBE triethylene glycol monobutyl ether
S-104 Surfynol 104 (surfactant of acetylene glycol manufactured by NISSIN CHEMICAL INDUSTRY CO., LTD.)
S-465 Surfynol 465 (surfactant of acetylene glycol manufactured by NISSIN CHEMICAL INDUSTRY CO., LTD.)
S-61 Surfynol 61 (surfactant of acetylene alcohol manufactured by NISSIN CHEMICAL INDUSTRY CO., LTD.)
TMP trimethylolpropane
TEG triethylene glycol
2-P 2-pyrolidone
TEA triethanolamine

[Table 10]

TABLE 10
Abrasion-Proof Property Test Result When
Heating Condition is changed in Example B-6

| | | | Abrasion-proof | | |
|---|---|---|---|---|---|
| | Temperature | Time | property | | |
| | (° C.) | (min) | Drying | Wetting | Property |
| Example B-6 | 150 | 5 | 5 | 5 | Normal |
| Reference | 100 | 5 | 3 | 3 | Normal |
| example B-11 | | | | | |
| Reference | 150 | 0.5 | 3 | 3 | Normal |
| example B-12 | | | | | |
| Reference | 210 | 5 | 4 | 4 | Fabric |
| example B-13 | | | | | yellowing |
| Reference | 210 | 1 | 4 | 4 | Fabric |
| example B-14 | | | | | yellowing |
| Reference | 100 | 20 | 3 | 3 | Normal |
| example B-15 | | | | | |

Hereinafter, the examples of Embodiment C including the polycarbodiimide as the reactant are described.

### Example C-1

### (1) Manufacture of Pigment Dispersion Element C1

In a pigment dispersion element C1, MONARCH 880 manufactured by Cabot Corporation of United States which is carbon black (pigment black 7) was used. By the same method as Japanese Unexamined Patent Application Publication No. 8-3498, the surface of the carbon black was oxidized so as to be dispersed in water and was used as the dispersion element C1. The particle diameter was measured to 110 nm using a microtrac particle size distribution measuring device UPA250 (manufactured by NIKKISO).

### (2) Manufacture of Polymer Fine Particle

A dripping device, a thermometer, a water cooling type recirculated condenser, and an agitator were included in a reaction vessel, 0.2 parts of potassium peroxodisulfate of a polymeric initiator was added at a nitrogen atmosphere of 70° C. while 100 parts of ion exchange water is inserted and agitated, and a monomer solution obtained by inserting 0.05 parts of sodium lauryl sulfate, 4 parts of glycidoxy acrylate, 15 parts of ethyl acrylate, 15 parts of butyl acrylate, 6 parts of tetrahydrofurfuryl acrylate, 5 parts of butyl methacrylate and 0.02 parts of t-dodecylmercaptane into 7 parts of ion exchange water was dripped at 70° C. to as to cause reaction, thereby manufacturing a primary material. 2 parts of ammonium persulfate 10% solution was added to the primary material and was agitated, a reaction solution including 30 parts of ion exchange water, 0.2 parts of sodium lauryl sulfate, 30 parts of ethyl acrylate, 25 parts of methyl acrylate, 6 parts of butyl acrylate, 5 parts of acrylic acid, and 0.5 parts of t-dodecylmercaptane was additionally added while being agitated at 70° C. so as to cause polymerization reaction, and neutralization was performed by sodium hydrate to set pH to 8 to 8.5, and a polymer fine particle water dispersion liquid filtered by a 0.3 μm filter was manufactured, thereby obtaining emulsion CA (EM-CA). After a portion of this polymer fine particle water dispersion liquid is dried, the glass transition temperature was measured to −15° C. by a differential scanning calorimeter (EXSTAR6000DSC manufactured by Seiko Instruments Inc.). The styrene-converted molecular weight when a solvent is measured by a THF using a Gel Permeation Chromatography (GPC) of an L7100 system manufactured by Hitachi, Ltd. was 150000. In addition, the acid value by a titration method was 20 mgKOH/g.

### (3) Manufacture of Ink for Ink Jet Recording

Hereinafter, an example of a composition suitable for the ink for ink jet recording is shown in Table 12. The manufacture of the ink for ink jet recording of the invention was performed by mixing of a vehicle component shown in Table 12 using the dispersion element C1 manufactured by the above method. In addition, in the remaining water of Examples, Reference Examples and Comparative Examples according to Embodiment C of the invention, a material obtained by adding 0.05% of Topside 240 (manufactured by Permachem Asia, Ltd.) for corrosion prevention of the ink, 0.02% of benzotriazole for corrosion prevention of the ink jet head member, and 0.04% of EDTA (ethylenediamine tetraacetate).2Na salt for reducing the influence of a metal ion in the ink system to ion exchange water was used.

### (4) Abrasion-Proof Property Test and Dry Cleaning Property Test

Using the ink of Example C-1 and using PX-V600 manufactured by Seiko Epson Corporation as the ink jet printer, cotton cloth was subjected to solid printing so as to prepare a sample and a heating treatment was performed for 5 minutes at 150° C. This sample was subjected to a rubbing fastness test of 200-times rubbing with a load of 300 g using a color fastness rubbing tester AB-301S of TESTER SANGYO CO., LTD. The examination of two levels of drying and wetting were performed by JIS (Japanese Industrial Standards) L0849 for checking peeling condition of the ink. Similarly, the dry cleaning test was evaluated by method B of JIS L0860. The result of the abrasion-proof property test and the dry cleaning test was shown in Table 11.

### (5) Measurement of Ejection Stability

Using PX-V600 manufactured by Seiko Epson Corporation as the ink jet printer, printing was performed with respect to A4-sized XeroxP paper manufactured by Fuji Xerox Co., Ltd. by 100 pages with a ratio of 4000 characters/page with MSP Gothic and the standard of a character size of 11 by Microsoft Word at an atmosphere of 35° C. and 35%, and an evaluation was performed. The result is shown in Table 11 such that a matter without printing disturbance is denoted by AA, a matter with one printing disturbance is denoted by A, a matter with two to three printing disturbances is denoted by B, a matter with four to five printing disturbances is denoted by C, and a matter with six or more printing disturbances is denoted by D.

### Example C-2

### (1) Manufacture of Pigment Dispersion Element C2

First, in a pigment dispersion element C2, pigment blue 15:3 (copper phthalocyanine pigment: manufactured by Clariant) was used. Nitrogen substitution was performed with respect to a reaction vessel including an agitator, a thermometer, a recirculated pipe and a dripping funnel, 75 parts of benzyl acrylate, 2 parts of acrylic acid, 0.3 parts of t-dodecylmercaptane were inserted, heating was performed to 70° C., 150 parts of benzyl acrylate, 15 parts of acrylic acid, 5 parts of butyl acrylate, 1 part of t-dodecylmercaptane, 20 parts of methyl ethyl ketone and 1 part of sodium persulfate, which are separately prepared, were inserted into the dripping funnel and were dripped to the reaction vessel for four hours, such that a dispersion polymer was subjected to polymerization reaction. Next, methyl ethyl ketone was added to the reaction vessel so as to manufacture a dispersion polymer solution having a concentration of 40%. After a portion of this polymer is dried, the glass transition temperature was measured to 40° C. by a differential scanning calorimeter (EXSTAR6000DSC manufactured by Seiko Instruments Inc.).

In addition, 40 parts of dispersion polymer solution, 30 parts of pigment blue 15:3, 100 parts of a 0.1 mol/L aqueous sodium hydroxide solution, and 30 parts of methyl ethyl ketone were mixed. Thereafter, dispersion was performed by 15 passes with 200 MPa using an ultrahigh-pressure homogenizer (an ultimizer HJP-25005 (manufactured by SUGINO MACHINE LIMITED)). Thereafter, this was transferred to another vessel, and 300 parts of ion exchange water was added, and agitation was performed for one hour. In addition, the total amount of methyl ethyl ketone and a portion of water were distilled using a rotary evaporator, and neutralization was performed by 0.1 mol/L sodium hydrate to set pH to 9. Thereafter, filtering was performed by a 0.3 μm membrane filter, adjustment was performed with ion exchange water, and a pigment dispersion element C2 having a pigment concentration of 15% was obtained. The particle diameter was measured to 80 nm by the same method as of Example C-1.

### (2) Manufacture of Polymer Fine Particle

A dripping device, a thermometer, a water cooling type recirculated condenser, and an agitator were included in a reaction vessel, 0.2 parts of potassium peroxodisulfate of a polymeric initiator was added at a nitrogen atmosphere of 70° C. while 100 parts of ion exchange water is inserted and agitated, and a monomer solution obtained by inserting 0.05 parts of sodium lauryl sulfate, 19 parts of ethyl acrylate, 15 parts of butyl acrylate, 6 parts of tetrahydrofurfuryl acrylate, 5 parts of butyl methacrylate and 0.02 parts of t-dodecylmercaptane into 7 parts of ion exchange water was dripped at 70° C. to as to cause reaction, thereby manufacturing a primary material. 2 parts of ammonium persulfate 10% solution was added to the primary material and was agitated, a reaction solution including 30 parts of ion exchange water, 0.2 parts of sodium lauryl sulfate, 30 parts of ethyl acrylate, 25 parts of methyl acrylate, 16 parts of butyl acrylate, 5 parts of acrylic acid, and 0.5 parts of t-dodecylmercaptane was additionally added while being agitated at 70° C. so as to cause polymerization reaction, and neutralization was performed by sodium hydrate to set pH to 8 to 8.5, and a polymer fine particle water dispersion liquid filtered by a 0.3 μm filter was manufactured, thereby obtaining emulsion CB (EM-CB). After a portion of this polymer fine particle water dispersion liquid is dried, the glass transition temperature was measured to −17° C. by a differential scanning calorimeter (EXSTAR6000DSC manufactured by Seiko Instruments Inc.). The molecular weight was measured to 200000 by the same method as Example C-1. In addition, the acid value by a titration method was 20 mgKOH/g.

### (3) Manufacture of Ink for Ink Jet Recording

Hereinafter, an example of a composition suitable for the ink for ink jet recording is shown in Table 12. The manufacture of the ink for ink jet recording of the invention was performed by mixing of a vehicle component shown in Table 12 using the dispersion element C2 manufactured by the above method, similar to Example C-1.

### (4) Abrasion-Proof Property Test and Dry Cleaning Property Test

Using the ink of Example C-2, the abrasion-proof property test and the dry cleaning property test were performed by the same method and the same evaluation method as Example C-1. The result of the abrasion-proof property test and the dry cleaning test was shown in Table 11.

### (5) Measurement of Ejection Stability

Using the ink of Example C-2, the measurement of the ejection stability was performed by the same method and the same evaluation method as Example C-1. The measured result of the ejection stability is shown in Table 11.

### Example C-3

### (1) Manufacture of Pigment Dispersion Element C3

First, a pigment dispersion element C3 was manufactured using pigment violet 19 (quinacridone pigment: manufactured by Clariant), similar to the pigment dispersion element C2. The particle diameter was measured to 90 nm by the same method as Example C-1.

### (2) Manufacture of Polymer Fine Particle

The same polymer fine particle as Example C-2 was used.

### (3) Manufacture of Ink for Ink Jet Recording

Hereinafter, an example of a composition suitable for the ink for ink jet recording is shown in Table 12. The manufacture of the ink for ink jet recording of the invention was performed by mixing of a vehicle component shown in Table 12 using the dispersion element C3 manufactured by the above method and was evaluated, similar to Example C-1.

### (4) Abrasion-Proof Property Test and Dry Cleaning Property Test

Using the ink of Example C-3, the abrasion-proof property test and the dry cleaning property test were performed by the same method and the same evaluation method as Example C-1. The result of the abrasion-proof property test and the dry cleaning test was shown in Table 11.

### (5) Measurement of Ejection Stability

Using the ink of Example C-3, the measurement of the ejection stability was performed by the same method and the same evaluation method as Example C-1. The measured result of the ejection stability is shown in Table 11.

### Example C-4

### (1) Manufacture of Pigment Dispersion Element C4

First, a pigment dispersion element C4 was manufactured using pigment yellow 14 (azo pigment: manufactured by Clariant), similar to the pigment dispersion element C2. The particle diameter was measured to 115 nm by the same method as Example C-1.

### (2) Manufacture of Polymer Fine Particle

The same polymer fine particle as Example C-2 was used.

### (3) Manufacture of Ink for Ink Jet Recording

Hereinafter, an example of a composition suitable for the ink for ink jet recording is shown in Table 12. The manufacture of the ink for ink jet recording of the invention was performed by mixing of a vehicle component shown in Table 12 using the dispersion element C4 manufactured by the above method and was evaluated, similar to Example C-1.

### (4) Abrasion-Proof Property Test and Dry Cleaning Property Test

Using the ink of Example C-4, the abrasion-proof property test and the dry cleaning property test were performed by the same method and the same evaluation method as Example C-1. The result of the abrasion-proof property test and the dry cleaning test was shown in Table 11.

### (5) Measurement of Ejection Stability

Using the ink of Example C-4, the measurement of the ejection stability was performed by the same method and the same evaluation method as Example C-1. The measured result of the ejection stability is shown in Table 11.

### Comparative Example C-1

In Comparative Example C-1, except that the total amount (45 parts) of ethyl acrylate is changed to 45 parts of benzyl methacrylate and a polymer fine particle having a glass transition temperature of 0° C. was used, the ink was manufactured similar to Example C-1 and was evaluated. Emulsion manufactured using this polymer fine particle was set to emulsion CC (EM-CC). The ink composition is shown in Table 12. The abrasion-proof property test, the dry cleaning property test and the ejection stability test were performed similar to Example C-1. The result is shown in Table 11.

### Comparative Example C-2

In Comparative Example C-2, except that the total amount (49 parts) of ethyl acrylate is substituted to benzyl methacrylate, 10 parts of butyl acrylate is changed to 10 parts of benzyl methacrylate and a polymer fine particle having a glass transition temperature of 10° C. was used, the ink was manufactured similar to Example C-2 and was evaluated. Emulsion manufactured using this polymer fine particle was set to emulsion CD (EM-CD). The ink composition is shown in Table 12. The abrasion-proof property test, the dry cleaning property test and the ejection stability test were performed similar to Example C-1. The result is shown in Table 11.

### Comparative Example C-3

In Comparative Example C-3, except that dispersion elements in which the particle diameter of a pigment is 350 nm and 45 nm were prepared, the ink was manufactured similar to Example C-3 and was evaluated. The particle diameter was measured by the same method as Example C-1. The dispersion element having the particle diameter of 350 nm was set to a pigment dispersion element C3A and a dispersion element having the particle diameter of 45 nm was set to a pigment dispersion element C3B. The ink composition is shown in Table 12. The abrasion-proof property test, the dry cleaning property test and the ejection stability test were performed similar to Example C-1. The result is shown in Table 11.

### Comparative Example C-4

In Comparative Example C-4, except that the polycarbodiimide (Carbodiright V-04 of NISSHINBO) is not used, the ink was manufactured similar to Example C-2 and was evaluated. The ink composition is shown in Table 12. The abrasion-proof property test, the dry cleaning property test and the ejection stability test were performed similar to Example C-1. The result is shown in Table 11.

### Comparative Example C-5

In Comparative Example C-5, except that the polycarbodiimide (Carbodiright V-04 of NISSHINBO) is not used, the ink was manufactured similar to Example C-3 and was evaluated. The ink composition is shown in Table 12. The abrasion-proof property test, the dry cleaning property test and the ejection stability test were performed similar to Example C-1. The result is shown in Table 11.

[Table 11]

TABLE 11
Result of Abrasion-Proof Property, Dry
Cleaning Property and Ejection Stability of Examples C-1 to
4 and Comparative Examples C-1 to 5

| | | | | Abrasion-proof | | | |
|---|---|---|---|---|---|---|---|
| | | Particle | | property | | Dry | |
| | | diam- | Acid | | Wet- | clean- | Ejection |
| | Tg | eter | value | Drying | ting | ing | stability |
| Example C-1 | −15 | 110 | 20 | ¾ | ¾ | ⅘ | A |
| Example C-2 | −17 | 80 | 20 | 5 | ⅘ | 5 | A |
| Example C-3 | −17 | 90 | 20 | 5 | 5 | 5 | A |
| Example C-4 | −17 | 115 | 20 | 5 | 5 | 5 | A |
| Comparative | 0 | 110 | 20 | 3 | 2 | 4 | A |
| example C-1 | | | | | | | |
| Comparative | 10 | 80 | 20 | ⅔ | ⅔ | 2 | A |
| example C-2 | | | | | | | |
| Comparative | −17 | 350 | 20 | 2 | 2 | ⅔ | D |
| example C-3 | −17 | 45 | 20 | ¾ | ¾ | 4 | C |
| Comparative | −17 | 80 | 20 | 2 | ½ | 5 | A |
| example C-4 | | | | | | | |
| Comparative | −17 | 90 | 20 | 3 | ⅔ | 5 | A |
| example B-5 | | | | | | | |

The unit of Tg is ° C., the particle diameter is the average particle diameter of the pigment and the unit thereof is nm, and the unit of the acid value is mgKOH/g.
The abrasion-proof property and the dry cleaning property follow the evaluation reference of JIS.

[Table 12]

TABLE 12
Ink Composition (mass %) of Examples C-1 to 4
and Comparative Examples C-1 to 5

| | Example | | | | Comparative example | | | | | |
|---|---|---|---|---|---|---|---|---|---|---|
| | C-1 | C-2 | C-3 | C-4 | C-1 | C-2 | C-3 | | C-4 | C-5 |
| Dispersion | 4.5 | — | — | — | 4.5 | — | — | — | — | — |
| Element C1 | | | | | | | | | | |
| Dispersion | — | 3.5 | — | — | — | 3.5 | — | — | 3.5 | — |
| Element C2 | | | | | | | | | | |
| Dispersion | — | — | 4.5 | — | — | — | — | — | — | 4.5 |
| Element C3 | | | | | | | | | | |
| Dispersion | — | — | — | 4.5 | — | — | — | — | — | — |
| Element C4 | | | | | | | | | | |
| Dispersion | — | — | — | — | — | — | 4.5 | — | — | — |
| Element | | | | | | | | | | |
| C3A | | | | | | | | | | |
| Dispersion | — | — | — | — | — | — | — | 4.5 | — | — |
| Element | | | | | | | | | | |
| C3B | | | | | | | | | | |
| EM-CA | 6.0 | — | — | — | — | — | — | — | — | — |
| EM-CB | — | 5.0 | 6.0 | 6.0 | — | — | 6.0 | 6.0 | 5.0 | 6.0 |
| EM-CC | — | — | — | — | 6.0 | — | — | — | — | — |
| EM-CD | — | — | — | — | — | 6.0 | — | — | — | — |
| V-02 | 2.0 | — | — | — | 2.0 | — | — | — | — | — |
| V-04 | 2.0 | 3.0 | 3.0 | 2.0 | 2.0 | 3.0 | 3.0 | 3.0 | | |
| 1,2-HD | 2.0 | 3.0 | 3.0 | 2.0 | 2.0 | 3.0 | 3.0 | 3.0 | 3.0 | 3.0 |
| 1,2-PD | — | — | — | 1.0 | — | — | — | — | — | — |
| TEGmBE | 2.0 | 1.0 | 1.0 | 2.0 | 2.0 | 1.0 | 1.0 | 1.0 | 1.0 | 1.0 |
| S-104 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.3 |
| S-61 | — | — | 0.2 | — | — | — | 0.2 | 0.2 | — | 0.2 |
| Glycerine | 10.0 | 12.0 | 10.0 | 10.0 | 10.0 | 12.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 5.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion | Residual | Residual | Residual | Residual | Residual | Residual | Residual | Residual | Residual | Residual |
| exchange | amount | amount | amount | amount | amount | amount | amount | amount | amount | amount |
| water | | | | | | | | | | |

The concentrations of the pigment and the polymer are denoted by solid content.
V-02 Polycarbodiimide (Carbodiright of NISSHINBO)
V-04 Polycarbodiimide (Carbodiright of NISSHINBO)
1,2-HD 1,2-hexanediol
1,2-PD 1,2-pentanediol
TEGmBE triethylene glycol monobutyl ether
S-104 Surfynol 104 (surfactant of acetylene glycol manufactured by NISSIN CHEMICAL INDUSTRY CO., LTD.)
S-465 Surfynol 465 (surfactant of acetylene glycol manufactured by NISSIN CHEMICAL INDUSTRY CO., LTD.)
S-61 Surfynol 61 (surfactant of acetylene alcohol manufactured by NISSIN CHEMICAL INDUSTRY CO., LTD.)
TMP trimethylolpropane
TEG triethylene glycol
2-P 2-pyrolidone
TEA triethanolamine

### Example C-6

### (1) Manufacture of Pigment Dispersion Element C5

In a pigment dispersion element C5, MA100 manufactured by Mitsubishi Chemical Corporation which is carbon black (PBk7) was used. The surface of the carbon black was oxidized by the same method as Japanese Unexamined Patent Application Publication No. 8-3498 so as to be dispersed in water and the dispersion element C5 was obtained. The particle diameter was measured to 120 nm by the same method as Example C-1.

### (2) Manufacture of Polymer Fine Particle

A dripping device, a thermometer, a water cooling type recirculated condenser, and an agitator were included in a reaction vessel, 0.3 parts of potassium peroxodisulfate of a polymeric initiator was added at a nitrogen atmosphere of 70° C. while 100 parts of ion exchange water is inserted and agitated, and a monomer solution obtained by inserting 0.05 parts of sodium lauryl sulfate, 20 parts of ethyl acrylate, 15 parts of butyl acrylate, 6 parts of lauryl acrylate, 5 parts of butyl methacrylate and 0.02 parts of t-dodecylmercaptane into 7 parts of ion exchange water was dripped at 70° C. to as to cause reaction, thereby manufacturing a primary material. 2 parts of ammonium persulfate 10% solution was added to the primary material and was agitated, a reaction solution including 30 parts of ion exchange water, 0.2 parts of sodium lauryl sulfate, 30 parts of ethyl acrylate, 25 parts of butyl acrylate, 16 parts of lauryl acrylate, 5 parts of acrylic acid, and 0.5 parts of t-dodecylmercaptane was additionally added while being agitated at 70° C. so as to cause polymerization reaction, and neutralization was performed by sodium hydrate to set pH to 8 to 8.5, and a polymer fine particle water dispersion liquid filtered by a 0.3 μm filter was prepared, thereby obtaining emulsion CI (EM-CI). After a portion of this polymer fine particle water dispersion liquid is dried, the glass transition temperature was measured to −19° C. by a differential scanning calorimeter (EXSTAR6000DSC manufactured by Seiko Instruments Inc.). The molecular weight was measured to 180000 by the same method as Example C-1. In addition, the acid value by a titration method was 18 mgKOH/g.

### (3) Manufacture of Ink for Ink Jet Recording

Hereinafter, an example of a composition suitable for the ink for ink jet recording is shown in Table 14. The manufacture of the ink for ink jet recording of the invention was performed by mixing of a vehicle component shown in Table 14 using the dispersion element C5 manufactured by the above method, similar to Example C-1.

### (4) Abrasion-Proof Property Test and Dry Cleaning Property Test

Using the ink of Example C-6, the abrasion-proof property test and the dry cleaning property test were performed by the same method and the same evaluation method as Example C-1. The result of the abrasion-proof property test and the dry cleaning test was shown in Table 13.

### (5) Measurement of Ejection Stability

Using the ink of Example C-6, the measurement of the ejection stability was performed by the same method and the same evaluation method as Example C-1. The measured result of the ejection stability is shown in Table 13.

### Example C-7

### (1) Manufacture of Pigment Dispersion Element C6

First, in a pigment dispersion element C6, pigment blue 15:3 (copper phthalocyanine pigment: manufactured by Clariant) was used. Nitrogen substitution was performed with respect to a reaction vessel including an agitator, a thermometer, a recirculated pipe and a dripping funnel, 45 parts of styrene, 30 parts of polyethylene glycol 400 acrylate, 10 parts of benzyl acrylate, 2 parts of acrylic acid, 0.3 parts of t-dodecylmercaptane were inserted, heating was performed to 70° C., 150 parts of styrene, 100 parts of polyethylene glycol 400 acrylate, 15 parts of acrylic acid, 5 parts of butyl acrylate, 1 part of t-dodecylmercaptane, 5 parts of sodium persulfate, which are separately prepared, were inserted into the dripping funnel and were dripped to the reaction vessel for four hours, such that a dispersion polymer was subjected to polymerization reaction. Next, water was added to the reaction vessel so as to prepare a dispersion polymer solution having a concentration of 40%. After a portion of this polymer is dried, the glass transition temperature was measured to 45° C. by a differential scanning calorimeter (EXSTAR6000DSC manufactured by Seiko Instruments Inc.).

In addition, 40 parts of dispersion polymer solution, 30 parts of pigment blue 15:3, and 100 parts of a 0.1 mol/L aqueous sodium hydroxide solution were mixed, and dispersion was performed using an Eiger mill using zirconia beads for two hours. Thereafter, this was transferred to another vessel, and 300 parts of ion exchange water was added, and agitation was performed for one hour. In addition, neutralization was performed by 0.1 mol/L sodium hydrate to set pH to 9. Thereafter, filtering was performed by a 0.3 μm membrane filter, and a pigment dispersion element C6 having a solid content (dispersion polymer and pigment blue is 15:3) of 20% was obtained. The particle diameter was measured to 100 nm by the same method as Example C-1. The molecular weight was measured to 210000 by the same method as Example C-1.

### (2) Manufacture of Polymer Fine Particle

A dripping device, a thermometer, a water cooling type recirculated condenser, and an agitator were included in a reaction vessel, 0.3 parts of potassium peroxodisulfate of a polymeric initiator was added at a nitrogen atmosphere of 70° C. while 100 parts of ion exchange water is inserted and agitated, and a monomer solution obtained by inserting 0.05 parts of sodium lauryl sulfate, 20 parts of ethyl acrylate, 25 parts of butyl acrylate, 6 parts of lauryl acrylate, 5 parts of butyl methacrylate and 0.02 parts of t-dodecylmercaptane into 7 parts of ion exchange water was dripped at 70° C. to as to cause reaction, thereby manufacturing a primary material. 2 parts of ammonium persulfate 10% solution was added to the primary material and was agitated, a reaction solution including 30 parts of ion exchange water, 0.2 parts of sodium lauryl sulfate, 20 parts of ethyl acrylate, 20 parts of butyl acrylate, 20 parts of lauryl acrylate, 5 parts of acrylic acid, and 0.5 parts of t-dodecylmercaptane was additionally added while being agitated at 70° C. so as to cause polymerization reaction, and neutralization was performed by sodium hydrate to set pH to 8 to 8.5, and a polymer fine particle water dispersion liquid filtered by a 0.3 μm filter was prepared, thereby obtaining emulsion CJ (EM-CJ). After a portion of this polymer fine particle water dispersion liquid is dried, the glass transition temperature was measured to −21° C. by a differential scanning calorimeter (EXSTAR6000DSC manufactured by Seiko Instruments Inc.). In addition, the acid value by a titration method was 18 mgKOH/g.

### (3) Manufacture of Ink for Ink Jet Recording

Hereinafter, an example of a composition suitable for the ink for ink jet recording is shown in Table 14. The manufacture of the ink for ink jet recording of the invention was performed by mixing of a vehicle component shown in Table 14 using the dispersion element C6 manufactured by the above method, similar to Example C-1.

### (4) Abrasion-Proof Property Test and Dry Cleaning Property Test

Using the ink of Example C-7, the abrasion-proof property test and the dry cleaning property test were performed by the same method and the same evaluation method as Example C-1. The result of the abrasion-proof property test and the dry cleaning test was shown in Table 13.

### (5) Measurement of Ejection Stability

Using the ink of Example C-7, the measurement of the ejection stability was performed by the same method and the same evaluation method as Example C-1. The measured result of the ejection stability is shown in Table 13.

### Example C-8

### (1) Manufacture of Pigment Dispersion Element C7

First, a pigment dispersion element C7 was manufactured using pigment red 122 (dimethylquinacridone pigment: manufactured by Clariant), similar to the pigment dispersion element C6. The particle diameter was measured to 80 nm by the same method as Example C-1.

### (2) Manufacture of Polymer Fine Particle

The same polymer fine particle as Example C-7 was used.

### (3) Manufacture of Ink for Ink Jet Recording

Hereinafter, an example of a composition suitable for the ink for ink jet recording is shown in Table 14. The manufacture of the ink for ink jet recording of the invention was performed by mixing of a vehicle component shown in Table 14 using the dispersion element C7 manufactured by the above method and was evaluated, similar to Example C-1.

### (4) Abrasion-Proof Property Test and Dry Cleaning Property Test

The abrasion-proof property test and the dry cleaning property test were performed using the ink of Example C-8 by the same method and the same evaluation method as Example C-1. The result of the abrasion-proof property test and the dry cleaning test was shown in Table 13.

### (5) Measurement of Ejection Stability

Using the ink of Example C-8, the measurement of the ejection stability was performed by the same method and the same evaluation method as Example C-1. The measured result of the ejection stability is shown in Table 13.

### Example C-9

### (1) Manufacture of Pigment Dispersion Element C8

First, a pigment dispersion element C8 was manufactured using pigment yellow 180 (benzimidazolone diazo pigment: manufactured by Clariant), similar to the pigment dispersion element C6. The particle diameter was measured to 130 nm by the same method as Example C-1.

### (2) Manufacture of Polymer Fine Particle

The same polymer fine particle as Example C-7 was used.

### (3) Manufacture of Ink for Ink Jet Recording

Hereinafter, an example of a composition suitable for the ink for ink jet recording is shown in Table 14. The manufacture of the ink for ink jet recording of the invention was performed by mixing of a vehicle component shown in Table 14 using the dispersion element C8 manufactured by the above method and was evaluated, similar to Example C-1.

### (4) Abrasion-Proof Property Test and Dry Cleaning Property Test

Using the ink of Example C-9, the abrasion-proof property test and the dry cleaning property test were performed by the same method and the same evaluation method as Example C-1. The result of the abrasion-proof property test and the dry cleaning test was shown in Table 13.

### (5) Measurement of Ejection Stability

Using the ink of Example C-9, the measurement of the ejection stability was performed by the same method and the same evaluation method as Example C-1. The measured result of the ejection stability is shown in Table 13.

### Reference Example C-1

In Reference Example C-1, except that the molecular weight of the added polymer fine particle is 90000 and 1100000, the ink was manufactured similar to Example C-6 and was evaluated. Emulsion having a molecular weight of 90000 was set to emulsion CK (EM-CK) and emulsion having a molecular weight of 1100000 was set to emulsion CL (EM-CL). The ink composition is shown in Table 14. The abrasion-proof property test, the dry cleaning property test and the ejection stability test were performed similar to Example C-6. The result is shown in Table 13. The measurement of the particle diameter of the polymer fine particle was performed by the same method as Example C-1.

### Reference Example C-2

In Reference Example C-2, except that 1,2-hexanediol as 1,2-alkyleneglycol is substituted by glycerine, the ink was manufactured similar to Example C-7 and was evaluated. The ink composition is shown in Table 14. The abrasion-proof property test, the dry cleaning property test and the ejection stability test were performed similar to Example C-6. The result is shown in Table 13.

### Reference Example C-3

In Reference Example C-3, except that the surfactant of acetylene glycol and the surfactant of acetylene alcohol are substituted by glycerine, the ink was manufactured similar to Example C-8 and was evaluated. The ink composition is shown in Table 14. The abrasion-proof property test, the dry cleaning property test and the ejection stability test were performed similar to Example C-6. The result is shown in Table 13.

### Reference Example C-4

In Reference Example C-4, except that the amount of added polymer fine particle is set to 80% and 50% in a ratio based on the pigment, the ink was manufactured similar to Example C-9 and was evaluated. The ink composition is shown in Table 14. The abrasion-proof property test, the dry cleaning property test and the ejection stability test were performed similar to Example C-6. The result is shown in Table 13.

### Reference Examples C-5 to 9

In Reference Examples C-5 to 9, except that a sample in which cotton cloth was subjected to solid printing is prepared and the condition that a heating treatment was performed for 5 minutes at 150° C. is variously changed, the abrasion-proof property test was evaluated similar to Example C-7. For comparison with Example C-7, the variously changed conditions are set to Reference Examples C-5 to 9, and the results are shown in Table 15.

[Table 13]

TABLE 13
Result of Abrasion-Proof Property, Dry
Cleaning Property and Ejection Stability of Examples C-6 to
9 and Reference Examples C-1 to 4

| | | | | | Ratio | | | | |
|---|---|---|---|---|---|---|---|---|---|
| | | | | | based | Abrasion-proof | | | |
| | | Particle | Acid | Molecular | on | property | | Dry | Ejection |
| | Tg | diameter | value | weight | pigment | Drying | Wetting | cleaning | stability |
| Example C-6 | −19 | 120 | 18 | 1.8 | 120 | 4 | 4 | 5 | A |
| Example C-7 | −21 | 100 | 18 | 2.0 | 150 | 5 | 5 | 5 | A |
| Example C-8 | −21 | 80 | 18 | 2.0 | 100 | 5 | 5 | 5 | A |
| Example C-9 | −21 | 130 | 18 | 2.0 | 120 | 5 | 5 | 5 | A |
| Reference | −19 | 120 | 18 | 0.9 | 120 | 3 | 3 | 2 | A |
| example C-1 | −19 | 120 | 18 | 11.0 | 120 | 3 | ⅔ | 3 | D |
| Reference | −21 | 100 | 18 | 2.0 | 150 | 5 | ⅘ | 5 | C |
| example C-2 | | | | | | | | | |
| Reference | −21 | 80 | 18 | 2.0 | 100 | ⅘ | ⅘ | 5 | C |
| example C-3 | | | | | | | | | |
| Reference | −21 | 130 | 18 | 2.0 | 80 | ¾ | ¾ | 3 | A |
| example C-4 | −21 | 130 | 18 | 2.0 | 50 | ⅔ | ⅔ | 2 | A |

The unit of Tg is ° C., the particle diameter is the average particle diameter of the pigment and the unit thereof is nm, and the unit of the acid value is mgKOH/g.
The molecular weight of Table 13 is ×10⁵.
The ratio based on the pigment is denoted by % of the polymer fine particle to the pigment.
The abrasion-proof property and the dry cleaning property follow the evaluation reference of JIS.

[Table 14]

TABLE 14
Ink Composition (mass %) of Examples C-6 to 9
and Reference Examples C-1 to 4

| | Example | | | | Reference example | | | | | |
|---|---|---|---|---|---|---|---|---|---|---|
| | C-6 | C-7 | C-8 | C-9 | C-1 | | C-2 | C-3 | C-4 | |
| Dispersion | 4.0 | — | — | — | 4.0 | 4.0 | — | — | — | — |
| Element C5 | | | | | | | | | | |
| Dispersion | — | 3.2 | — | — | — | — | 3.2 | — | — | — |
| Element C6 | | | | | | | | | | |
| Dispersion | — | — | 4.0 | — | — | — | — | 4.0 | — | — |
| Element C7 | | | | | | | | | | |
| Dispersion | — | — | — | 4.0 | — | — | — | — | 4.0 | 4.0 |
| Element C8 | | | | | | | | | | |
| EM-CI | 5.0 | — | — | — | — | — | — | — | — | — |
| EM-CJ | — | 4.8 | 4.0 | 5.0 | — | — | 4.8 | 4.0 | 3.2 | 2 |
| EM-CK | — | — | — | — | 5.0 | — | — | — | — | — |
| EM-CL | — | — | — | — | — | 5.0 | — | — | — | — |
| V-04 | 2.0 | 3.0 | 3.0 | 2.0 | 2.0 | 2.0 | 3.0 | 3.0 | 2.0 | 2.0 |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerine | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion | Residual | Residual | Residual | Residual | Residual | Residual | Residual | Residual | Residual | Residual |
| exchange | amount | amount | amount | amount | amount | amount | amount | amount | amount | amount |
| water | | | | | | | | | | |

The concentrations of the pigment and the polymer are denoted by solid content.
V-04 Polycarbodiimide (Carbodiright of NISSHINBO)
1,2-HD 1,2-hexanediol
1,2-PD 1,2-pentanediol
TEGmBE triethylene glycol monobutyl ether
S-104 Surfynol 104 (surfactant of acetylene glycol manufactured by NISSIN CHEMICAL INDUSTRY CO., LTD.)
S-465 Surfynol 465 (surfactant of acetylene glycol manufactured by NISSIN CHEMICAL INDUSTRY CO., LTD.)
S-61 Surfynol 61 (surfactant of acetylene alcohol manufactured by NISSIN CHEMICAL INDUSTRY CO., LTD.)
TMP trimethylolpropane
TEG triethylene glycol
2-P 2-pyrolidone
TEA triethanolamine

[Table 15]

TABLE 15
Abrasion-Proof Property Test Result When
Heating Condition is changed in Example C-7

| | | | Abrasion-proof | | |
|---|---|---|---|---|---|
| | Temperature | Time | property | | |
| | (° C.) | (min) | Drying | Wetting | Property |
| Example C-7 | 150 | 5 | 5 | 5 | Normal |
| Reference | 100 | 5 | 3 | 3 | Normal |
| example C-5 | | | | | |
| Reference | 150 | 0.5 | 3 | 3 | Normal |
| example C-6 | | | | | |
| Reference | 210 | 5 | 4 | 4 | Fabric |
| example C-7 | | | | | yellowing |
| Reference | 210 | 1 | 4 | 4 | Fabric |
| example C-8 | | | | | yellowing |
| Reference | 100 | 20 | 3 | 3 | Normal |
| example C-9 | | | | | |

1-14. (canceled)

15. An ink composition comprising: a dispersion element having an average particle diameter of 50 nm to 300 nm, which allows a pigment to be dispersed in water; polymer fine particles synthesized using at least alkyl(meth)acrylate and/or cyclic alkyl(meth)acrylate as components thereof, having a glass transition temperature of −10 C or less and having an acid value of 100 mgKOH/g or less; and a reactant.

16. The ink composition according to claim 15, wherein the reactant is at least one kind selected from the group consisting of block isocyanate, oxazoline-containing polymer and polycarbodiimide.

17. The ink composition according to claim 15, wherein the alkyl(meth)acrylate and/or the cyclic alkyl(meth)acrylate are/is alkyl(meth)acrylate having 1 to 24 carbon atoms and/or cyclic alkyl(meth)acrylate having 3 to 24 carbon atoms.

18. The ink composition according to claim 15, wherein the dispersion element is a self-dispersion carbon black of which an average particle diameter is 50 nm to 300 nm so as to be dispersed in water without a dispersion agent.

19. The ink composition according to claim 15, wherein the dispersion element has an average particle diameter of 50 nm to 300 nm so as to allow an organic pigment to be dispersed in water using a polymer, and a styrene-converted weight-average molecular weight by Gel Permeation Chromatography (GPC) of the polymer is 10000 to 200000.

20. The ink composition according to claim 15, wherein in the polymer fine particle, a styrene-converted weight-average molecular weight by Gel Permeation Chromatography (GPC) is 100000 to 1000000.

21. The ink composition according to claim 15, comprising 1,2-alkylene glycol.

22. The ink composition according to claim 15, comprising a surfactant of acetylene glycol and/or a surfactant of acetylene alcohol.

23. The ink composition according to claim 15, wherein the content (mass %) of the polymer fine particle is greater than the content (mass %) of the pigment.

24. An ink for ink jet recording comprising the ink composition according to claim 15.

25. An ink jet recording method comprising printing the ink for ink jet recording according to claim 24 on a fabric, and heating the fabric, on which the ink for ink jet recording is printed, at 110 C to 200 C for 1 or more minutes.

26. The ink jet recording method according to claim 25, comprising printing the ink for ink jet recording on the fabric and treating the fabric with an acidic liquid before the fabric on which the ink for ink jet recording is printed is heated, if the ink for ink jet recording contains carbodiimide as the reactant.

27. A method for producing an ink jet recorded matter, the method comprising printing the ink for ink jet recording according to claim 24 on a fabric, and heating the fabric, on which the ink is printed, at 110 C to 200 C for 1 or more minutes.

28. An ink jet recorded matter obtained by the ink jet recording method according to claim 25.

29. An ink jet recorded matter obtained by the method for producing the ink jet recorded matter according to claim 27.
